(19) United States
(12) Patent Application Publication
(10) Pub. No.: US 2018/0125748 A1
(43) Pub. Date: May 10, 2018

(54) Devices, Mediums, Systems And Methods For Facilitating Female Sexual Arousal

(71) Applicant: Aytu Women's Health, LLC., Englewood, CO (US)

(72) Inventors: Alex GOLDENBERG, San Francisco, CA (US); Jessica LIBERATORE, San Mateo, CA (US); Stephen Andrew WILSON, Mountain View, CA (US); Eric GOLDFARB, Belmont, CA (US)

(21) Appl. No.: 15/569,042

(22) PCT Filed: Apr. 23, 2016
(86) PCT No.: PCT/US2016/029078

§ 371 Date: Oct. 24, 2017

Related U.S. Application Data
(60) Provisional application No. 62/152,597, filed on Apr. 24, 2015.

(51) Int. Cl. A61H 23/04; A61H 9/00; A61H 19/00; A61H 23/02

(52) U.S. Cl. CPC A61H 23/04; A61H 2201/5097; A61H 19/34; A61H 23/0218; A61H 23/0263; A61H 2201/0176; A61H 2201/018; A61H 2201/165; A61H 2201/5002; A61H 2201/5005; A61H 2201/5015; A61H 2201/5038; A61H 2201/5071; A61H 2201/5082; A61H 2201/5084; A61H 9/0057

(57) ABSTRACT

Devices, mediums, systems and methods for promoting female sexual arousal are provided and described. In one embodiment, the device includes a pump for evacuating a suction chamber when attaching the suction chamber to the female's tissue and a controller configured to self-regulate to turn on and off the pump to maintain a certain level of pressure. The controller is additionally or alternatively configured to activate the pump and to activate a feedback indicator distinct from the pump upon the sensor detecting a pressure value above ambient pressure whereby the feedback indicator advises the female as to the status of evacuation. The device can further additionally or alternatively include at least one sensor for measuring the temperature of the at least one stimulator in the vicinity of the stimulation and a controller electrically coupled to the at least one stimulator and the at least one sensor for controlling the at least one stimulator during a maximum power session.

### FIELD OF THE INVENTION

The invention relates generally to devices, mediums, systems and methods for promoting female sexual wellness and, more particularly, to devices, mediums, systems and methods for promoting female sexual arousal.

### BACKGROUND OF THE INVENTION

Clitoral vascular engorgement plays an important role in female sexual desire, arousal and satisfaction. Sexual arousal results in smooth muscle relaxation and arterial vasodilation within the clitoris. The resultant increase in blood flow leads to tumescence of the glans clitoris and increased sexual arousal.

Female sexual wellness and satisfaction can be addressed by embodiments of the present invention.

### SUMMARY OF THE DISCLOSURE

Briefly and in general terms, the present disclosure is directed towards a sexual arousal device for use by a female. In one approach the device includes a suction chamber adapted to engage the female's tissue surrounding her clitoris, the suction chamber being configured to allow the clitoris to expand during use, and a pump for evacuating the suction chamber when attaching the suction chamber to the female's tissue. The device can additionally include a sensor for measuring pressure, at least one stimulator for stimulating the clitoris in the chamber and a controller electrically coupled to the pump. In one particular aspect, the controller is configured to self-regulate to turn on and off the pump to maintain a certain level of pressure.

In certain embodiments, the controller is configured to activate the pump and to activate a feedback indicator distinct from the pump upon the sensor detecting a pressure value above ambient pressure whereby the feedback indicator advises the female as to the commencement of evacuation.

In certain embodiments, the device additionally or alternatively includes at least one stimulator for engaging the clitoris in the chamber and a controller electrically coupled to the pump and configured to activate the pump for evacuating the suction chamber, the controller being configured after activating the pump to activate a feedback indicator distinct from the pump to advise the female as to the status of evacuation.

The present disclosure is also directed towards a sexual arousal device for use by a female, comprising a suction chamber adapted to engage the female's tissue surrounding her clitoris, at least one stimulator for stimulating the clitoris in the chamber, at least one sensor for measuring the temperature of the at least one stimulator in the vicinity of the stimulation. The device can additionally include a controller electrically coupled to the at least one stimulator and the at least one sensor for controlling the at least one stimulator during a maximum power session, the controller being configured to reduce the maximum power to the at least one stimulator during the maximum power session upon the at least one sensor detecting a temperature value that approaches a predetermined maximum temperature value so as to maintain continuous operation of the at least one stimulator throughout the maximum power session without causing heat damage to the clitoris.

In yet other embodiments, there is provided a miniature pump including a voice coil magnet and an electromagnetic coil moveable relative to the magnet when energy is supplied to the coil, a support member coupled to the coil and a diaphragm and permanent magnet coupled to the support member and moveable with the coil and support member wherein the permanent magnet urges the support member towards the voice coil magnet, a controller electrically coupled to the coil for selectively providing energy to the coil in a waveform centered by a first amplitude on an offset energy level. The pump can additionally include a controller that is configured upon activation of the pump to provide initial energy to the coil at a second amplitude greater than the first amplitude to counteract the force of the permanent magnet upon commencement of oscillation of the diaphragm. Alternatively or additionally, the pump includes a controller configured upon deactivation of the pump to gradually reduce energy to the coil at a negative slope from the offset energy level to zero so as to gently return the support member to the rest position.

These and other features of the disclosure will become apparent to those persons skilled in the art upon reading the details of the specification as more fully described below.

### BRIEF DESCRIPTION OF THE DRAWINGS

FIGS. 1A through 1D illustrate various views of a device according to an embodiment of the invention.

FIGS. 2A and 2B illustrate views of a device and a controller according to an embodiment of the invention.

FIG. 3 illustrates a view of a device according to an embodiment of the invention.

FIGS. 4A through 4E illustrate use of various embodiments of the invention.

FIGS. 5A through 5C illustrate user interfaces for a smartphone-type controller.

FIG. 6 is a perspective, phantom view of an integrated device.

FIG. 7 depicts an exploded view of a device according to aspects of the invention.

FIG. 8 illustrates a perspective view of a miniature pump of the device according to an embodiment of the invention.

FIG. 9 illustrates a cross-section of the perspective view of FIG. 8.

FIG. 10 illustrates an exploded perspective view of a miniature pump according to an embodiment of the invention.

FIG. 11 illustrates a close up view of the cross-sectional view of FIG. 9.

FIGS. 12A and 12B illustrate a perspective view and a plan view, respectively, of a cross-section of a portion of a miniature pump according to certain embodiments.

FIGS. 13A and 13B illustrate schematics of the mechanism of interaction between the actuator and the diaphragm of a miniature pump according to certain embodiments.

FIG. 14 is a graphical depiction of an efficiency comparison between a miniature electromagnetic diaphragm pump using an additional loading magnet according to an embodiment of the invention and an electromagnetic diaphragm pump without a loading magnet.

FIGS. 15A and 15B illustrate a perspective view and a plan view, respectively, of a cross-section of a portion of a miniature pump body according to certain embodiments.

FIG. 16 illustrates an exploded perspective view of an embodiment of a miniature pump.

FIGS. 17A and 17B illustrate different views of a cross-section of a portion of one embodiment of a blow-off valve.

FIGS. 18A and 18B illustrate exterior views of a blow-off valve according to some embodiments of the present invention.

FIGS. 19A and 19B illustrate different views of a lower pump body according to some embodiments of the present invention.

FIGS. 20A, 20B, and 20C illustrate different views of an upper pump body according to some embodiments of the present invention.

FIGS. 21A, 21B, and 21C illustrate different views of a lower valve assembly body according to some embodiments of the present invention.

FIGS. 22A and 22B illustrate different views of an upper valve assembly body according to some embodiments of the present invention.

FIG. 23A illustrates a control and I/O subsystem including a number of control, storage and I/O components according to some embodiments of the present invention.

FIG. 23B shows a flowchart illustrating a number of steps performed by a processor to dynamically control a diaphragm according to pressure values measured by a sensor according to some embodiments of the present invention.

FIG. 23C illustrates an exemplary evolution over a number of pump cycles of several parameters described above, according to some embodiments of the present invention.

FIG. 23D shows an exemplary sequence of steps performed by a control system to implement an auto-attach mode according to some embodiments of the present invention.

FIG. 23E shows an exemplary sequence of steps performed by a control system to attain a target negative pressure in a suction cavity of a device of the invention.

FIG. 23F shows an exemplary sequence of steps performed by a control system to maintain the pressure in a suction cavity of a device of the invention within an operational vacuum range.

FIG. 24 illustrates an exemplary energy waveform for driving the miniature pump of the device of the invention.

FIG. 25A shows a state diagram for an exemplary system-level finite state machine according to some embodiments of the present invention.

FIG. 25B shows a state diagram for an exemplary attachment-management finite state machine according to some embodiments of the present invention.

FIG. 26A shows an exemplary on-device user interface according to some embodiments of the present invention.

FIG. 26B shows an exemplary dedicated remote control user interface according to some embodiments of the present invention.

FIG. 26C shows an exemplary smartphone application user interface according to some embodiments of the present invention.

### DETAILED DESCRIPTION OF THE INVENTION

Embodiments of the present invention described herein, including the figures and examples, are useful for promoting female sexual wellness and function.

Before the present devices and methods are described, it is to be understood that this invention is not limited to particular embodiments described. It is also to be understood that the terminology used herein is for the purpose of describing particular embodiments only, and is not intended to be limiting, since the scope of the present invention will be limited only by the appended claims.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

Short summaries of certain terms are presented in the description of the invention. Each term is further explained and exemplified throughout the description, figures, and examples. Any interpretation of the terms in this description should take into account the full description, figurers, and examples presented herein.

The singular terms “a,” “an,” and “the” include plural referents unless the context clearly dictates otherwise. Thus, for example, reference to an object can include multiple objects unless the context clearly dictates otherwise. Similarly, references to multiple objects can include a single object unless the context clearly dictates otherwise.

The terms “substantially,” “substantial,” and the like refer to a considerable degree or extent. When used in conjunction with an event or circumstance, the terms can refer to instances in which the event or circumstance occurs precisely as well as instances in which the event or circumstance occurs to a close approximation, such as accounting for typical tolerance levels or variability of the embodiments described herein.

The term “about” refers to a value, amount, or degree that is approximate or near the reference value. The extent of variation from the reference value encompassed by the term “about” is that which is typical for the tolerance levels or measurement conditions.

The term “stimulator” refers to elements that provide stimulation using mechanical motion (such as vibration), electrical stimulation, temperature, or other sensory stimulation.

All recited connections may be direct connections and/or indirect operative connections through intermediary structure.

A set of elements includes one or more elements.

Unless otherwise stated, performing a comparison between two elements encompasses performing a direct comparison to determine whether one element is larger (or larger than equal to) the other, as well as an indirect comparison, for example by comparing a ratio or a difference of the two elements to a threshold.

Unless otherwise required, any described method steps need not be necessarily performed in a particular illustrated order. A first element, for example data, derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. Computer readable media includes non-transitory storage media such as magnetic, optic, and semiconductor media, as well as communications links such as conductive cables and fiber optic links. Semiconductor media includes magnetic and other hard drives, optical drives and disks, flash memory and dynamic random access memory (DRAM). According to some embodiments, the present invention includes computer systems, controllers, mobile communication devices and/or any other suitable computing device programmed or configured to perform some or all of the methods described herein, for example either through firmware, software or both, as well as in some instances computer-readable media encoding instructions to perform some or all of the methods described herein.

We have discovered that engorgement and vibration together are a powerful combination such that engorgement creates a more suitable mechanical back-board for the pacinian corpuscles to be stimulated and that applying both simultaneously should produce more profound effects than either applied alone. In both sexes, engorgement of the sexual organs is the key physiological target in that engorgement is fundamental to achieve an SSE. Embodiments described herein provide methods and devices for engorging sexual organs to better propagate vibrational energy.

Certain prior art stimulation devices, such as vibrators, provide relatively diffuse stimuli. That is, the vibrating motion supplied by a vibrator is applied relatively evenly over the clitoris and surrounding tissue. In certain vibrating devices that are capable of delivering vibration over a more tightly focused area, the frequency and magnitude of the vibration may still present a relatively diffuse vibratory motion to clitoral tissue. Additionally, much of the vibration of prior art vibrators is lost in vibrating the handle, housing and the user's hand or other portion of their body.

Advantageously, certain embodiments described herein are capable of providing complex patterns of suction. Such complex suction waveforms can provide a comparatively organic stimulation experience as compared to prior art mechanical stimulation devices. For some users, the variable suction patterns, algorithms waveforms of certain embodiments can provide engorgement and stimulation such that effective arousal is achieved without the use of vibration.

Certain embodiments of the present invention are related to systems, methods and computer-readable media for promoting female sexual arousal; for managing an attachment of a suction device to a user's tissue, in particular using an auto-attachment operating mode; and for managing an operation of a suction pump of such a device according to indicators of leaks and/or quality of the seal established between the device and user tissue.

Certain embodiments of devices disclosed herein use suction to draw tissue into contact with vibrating elements. Certain devices remain in contact with tissue by virtue of the suction applied to the tissue. Yet another benefit of isolating vibration in devices is that the airtight seal between the device and tissue is not substantially disrupted by the vibration. This type of vibration isolation involves substantially isolating the sealing elements of the device from the vibrating elements in the device.

The compact size of devices disclosed herein makes them capable of being discreetly worn and capable of being carried in a purse. Yet, devices disclosed herein are sized and configured to be accessible and controllable while being worn. Devices disclosed herein may be usable prior to and during intercourse or as a program for recruitment of blood flow and nerve sensitization of tissue. Devices disclosed herein may be adjustable and customizable and provide selectable, variable suction and vibrational properties. Devices disclosed herein may be capable of being controlled remotely, such as by a smartphone. Devices discloses herein may be capable of promoting and/or sustaining female sexual arousal.

Advantageously, devices disclosed herein use relatively low power motors to produce focused, spatially-differentiated vibration.

In certain embodiments, proper placement can be achieved by activating one or more motors to a detectable level of vibration to allow the user to center the stimulatory effect about the clitoris. By pre-activating the motors during placement, the user can customize the fit and determine the most effective location for vibrational simulation and/or suction stimulation.

Specific aspects of the device features may include some or all of the following: (i) the user is able to set suction to the level that is comfortable to them; (ii) the user is able to detach the suction tube from the device without losing vacuum pressure that leads to device detachment; (iii) the user is able to control vibration function by means of wireless remote control; (iv) the user interface is via iOS, Android, or other mobile operating system application on a Bluetooth enabled device or via an RF or Bluetooth key fob styled controller; (v) the user is able to control vibration parameters such as pattern transition speed and vibration amplitude; (vi) power is provided via an internal rechargeable battery, not accessible to the user; (vii) the user is able to control/direct vibration focus through pointing with finger on a wireless enabled device; (viii) the user is able to control degree of motor overlap; (ix) the motor overlap optimized for organic feel; (x) the device is enabled with basic rotational motor patterns; (xi) the device withstands an external force applied to the external shell (over the attachment area) by the user; (xii) the shell withstands sufficient vacuum cycles without loss of integrity; (xiii) the user is able to customize the motor pattern including direction, motor selection, looping, and save/recall the customized pattern; and (xiv) the user is able to customize the suction pattern and save/recall the customized pattern. Studies have shown that different areas of the female brain are activated when the clitoris is self-stimulated than when the clitoris is stimulated by a partner and that often times a female can achieve orgasm easier through self-stimulation than when stimulated by a partner. With the certain embodiments of the devices described herein, the female can record the stimulation pattern that allows her to achieve orgasm through self-stimulation and store it in the devices memory. Subsequently, the device can be used during intercourse to play the saved pattern such that the female can achieve orgasm as if she were self-stimulating.

Preferred attributes of certain embodiments include: (i) user adjustable suction for fixation and blood flow recruitment; (ii) user adjustable vibration for blood flow recruitment and nerve stimulation; (iii) spatially differentiated stimulation via macro-motion or isolation & control of multiple stimulation sources; (iv) tether-less and wearable during intercourse; and (v) customizable & reusable.

Certain embodiments of the device include onboard circuitry, power, pump, or other electronic features. For example, the device includes an antenna for interacting with the remote controller, such as an RF antenna. The device includes a battery.

Certain embodiments of the device are controlled by a remote drive connected via drive cable to vibratory and/or suction elements inside the wearable part of the device.

Certain embodiments of the device provide variable suction. In such embodiments, the user may rapidly and easily adjust the suction levels. Further, in certain embodiments the variable suction is programmable such that the amount of suction applied by the device can vary according to a pattern. In some instances, the suction pattern is complementary to the vibration and/or macroscopic motion patterns. The device controller includes a means for controlling the suction patterns, pre-loaded suctions patterns, user-configurable suctions patterns, or combinations thereof. The device controller enables the user to selected pre-loaded combinations of a suction pattern, a vibrational pattern, and/or a macroscopic motion pattern and also enables the user to design and select customized combinations.

Certain embodiments of the present invention are related to devices and methods for improving the efficiency of miniature diaphragm pumps and in particular miniature diaphragm pumps driven by electromagnetic actuators.

In some embodiments, the miniature diaphragm pump is loaded with energy during the exhaust stroke and the loaded energy is released during the pump stroke, which improves the efficiency of the miniature pump.

In some embodiments, a supplemental permanent magnet is fixed to a diaphragm of a miniature electromagnetically driven diaphragm pump. The supplemental permanent magnet is separated from a fixed pole magnet during the exhaust stroke of the pump and is magnetically attracted to the fixed pole magnet during the pump stroke. Separating the permanent magnet from the pole magnet loads energy during the exhaust stroke.

Certain embodiments of the present invention include a control system for operating a miniature diaphragm pump. The control system can include control, storage, sensing, and I/O components.

Certain embodiments of the present invention include a processor for dynamically controlling the position and/or performance of the diaphragm in the miniature diaphragm pump. In some embodiments, the offset and/or the gain is dynamically controlled in response to measured operational parameters in order to achieve desired operational characteristics.

The control systems, software, firmware, algorithms, and system architecture disclosed herein can be used in connection with devices disclosed in U.S. provisional application 61/981,836, filed Apr. 20, 2014, titled “Devices and Methods for Promoting Female Sexual Wellness” which is hereby incorporated herein, in its entirety, by reference.

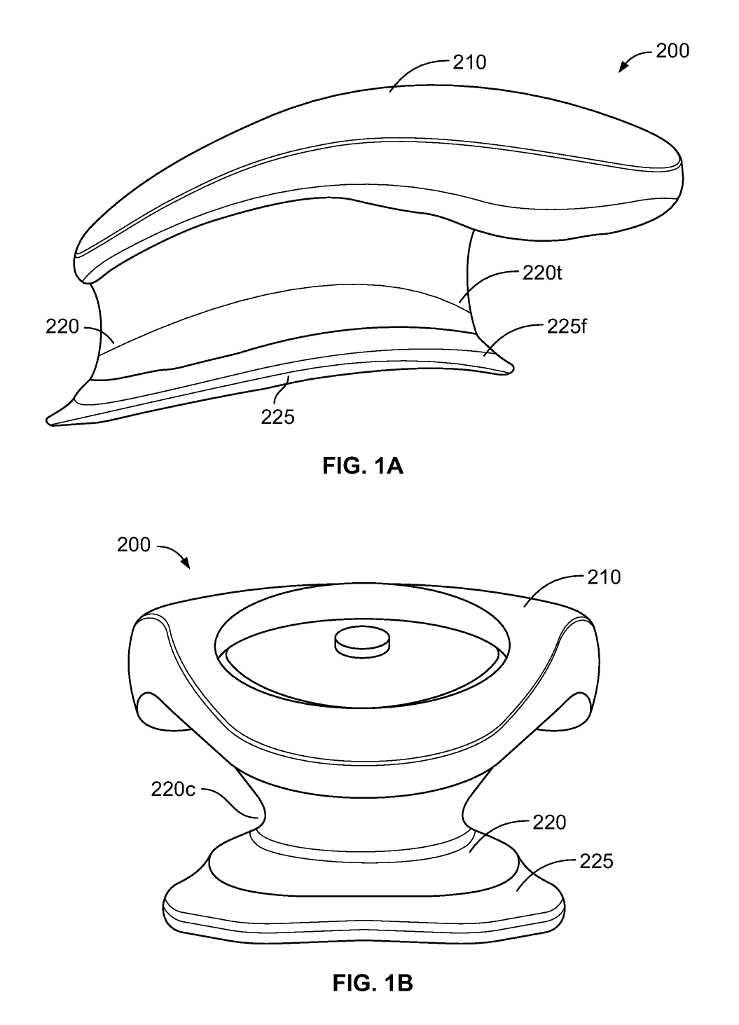

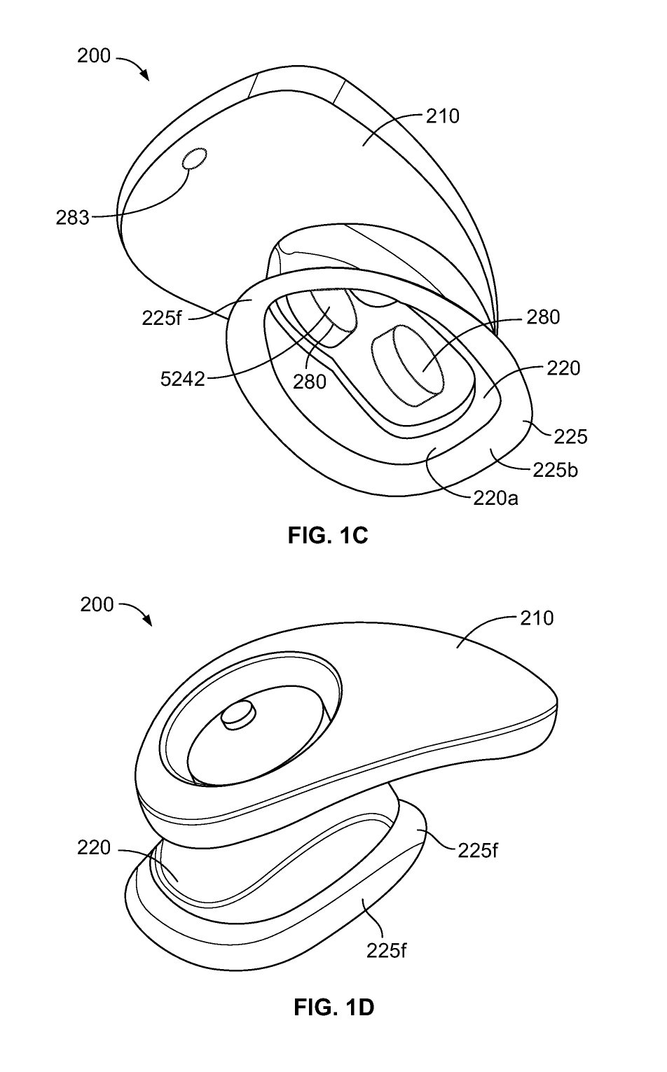

FIGS. 1A, 1B, 1C, and 1D illustrate different views of an embodiment of a female sexual arousal device or apparatus of the invention, also sometimes referred to herein as a sexual arousal device or apparatus, female arousal device or apparatus, or device or apparatus. Device 200 includes device body 210, which can house controller circuitry, for example controller block or circuit 215, and suction chamber 220. The controller of device 200, which can include controller block or circuit 215 or any components thereof, can be configured to operate the device, including any or all of the electrical components thereof. Chamber 220 may be referred to by other names, such as a chamber, vacuum chamber or tissue chamber. The controller circuitry can be accessed using an interface mounted on device body 210 and/or via a remote controller. The remote controller can be physically tethered to device body 210 or it can be wirelessly connected. Suction body 220 includes sealing and flange 225, which is adapted to provide a substantially airtight seal against tissue. In one embodiment, flange 225 is substantially rigid so as to retain its shape during use, but can additionally be elastic so as to facilitate engagement with the user and enable a suction or fluid-tight fit between flange 225 and the user. In one embodiment, at least flange 225 is made from a suitable elastic material such as silicone. The various views of FIGS. 1A, 1B, 1C, and 1D illustrate certain features of the shape and form of device 200 which promote comfortable, discreet, and secure attachment of device 200. For example, device 200 is sized such that the attachment area, which can be defined by the area where sealing flange 225 meets opening 220a of suction chamber 220, fits between the labia majora inferior to the clitoris and device body 210 may exit the labia majora superior to the clitoris. Further, the taper of the outer upper section of suction chamber 220 facilitates comfortable, discreet, and secure fit. The curve of device body 210 can help device 200 conform to the user and allow discreet placement inside garments. In one embodiment, one or more suitable feedback indicators such as light emitting diodes (LEDs) 283 can be provided on the inside of the device body 21, for example on the underside of the device body 21. The feedback indicator(s) 283 can be utilized for any variety of purposes, such as providing feedback to the user during the placement or operation of the device 200 or both. In one embodiment, one or more LEDS can be provided inside device body 210, for example inside cover 5201 on a circuit board of controller block 215. The LED(s) can illuminate though cover 5201, which in one embodiment can have at least a portion of which is translucent. In one embodiment, a single multi-color LED is provided inside cover 5201 for illuminating through the cover 5201. Such multi-color LED can, for example, alternatively illuminate in the colors purple, green and red.

In one embodiment, the front section 225f of sealing flange 225 is placed superior to the clitoris and tucked under the anterior commissure of the labia majora. In one embodiment, the front section 225f of the sealing flange has contour to sealingly engage the user under the anterior commissure of the labia majora. In that position, the labia majora inferior to the anterior commissure can snugly engage the tapered section 220t of suction chamber 220 such that substantially the entire front and lateral portions of the sealing flange 225 are tucked under the labia majora. Advantageously, the tapered section 220t of suction chamber 220 allows the labia majora to comfortably and sealingly engage a comparatively narrower section of the device while vaginal tissue superior to the vaginal orifice can sealingly engage the comparatively wider sealing flange 225. In one embodiment, flange 225 is sized and shaped to fit over a clitoris of a user and suction chamber is larger than the clitoris of the user. In one embodiment, lower or bottom surface 225b of the flange 225 can have a shape approximating the shape of the tissue surrounding the clitoris, for example the tissue surrounding the clitoris interior of the labia majora, so as to promote or facilitate a fluid-tight, sealable or suction fit between the flange 225 and such tissue. In one embodiment, the suction chamber 220 is configured to all the clitoris to expand during use of the device 200.

Proper placement of device 200 can be easily and repeatably achieved by following a few steps. For example, when a user first attempts to place the device, they may benefit from the use of a mirror such that the user's head and shoulders are propped up and they can use the mirror to observe themselves placing the device. The user can open their outer labia so that they can see their inner labia and the hooded glans of the clitoris. Users can identify a groove within their outer labia that runs along the inner labia at the bottom and the hooded clitoris at the top. Device 200 can be effective when the sealing flange 225 is centered over the clitoris and the comparatively soft edges of the sealing flange 225 fit into the groove. In some cases the user can tug their outer labia to make space for the outer ring to fit snugly in the groove. The vibratory motors can then fit snugly around the glans of the clitoris. In some instances, the user can apply an amount of a lubricant (such as a water-based lubricant) to coat their inner and outer labia, the glans of the clitoris, the hood of the clitoris, and the comparatively soft edges of the sealing flange 225. The user can activate the vibratory motors at a relatively low power setting to help place the device. By using the sensation from the low power vibrations as a guide, the user can ensure that the clitoris is placed snugly within the space defined by the inner portions of the vibratory motors. In some cases, the user can apply stimulation with their inner labia separated. A properly placed device will be high enough on the user's vulva to effectively cup the clitoris and not block the urethra or the vaginal opening.

In certain embodiments, one or more active stimulators are carried by the device of the invention to stimulate the user's clitoris when the device is mounted to the user's tissue about the clitoris. The active stimulators can be of any suitable type, and can include any suitable vibrating, oscillating or other source for stimulating the user's clitoris. The stimulators of the invention can include one or more vibratory-disc, miniature coin-style, pneumatic or other motors that stimulate multiple regions or areas of the clitoris during use of the device. The stimulators of the invention includes a motor or other movement source that stimulates as single area or multiple areas. In one embodiment, the one or more active stimulators are embedded in the wall of a flexible suction chamber. In one embodiment, three active stimulators 280 are provided, as illustrated in FIG. 1C. In certain embodiments, the motors are embedded in a flexible membrane, which is attached to the walls of the suction chamber. When suction is applied, tissue is brought into contact with the stimulator. The motors can be controlled by controller circuitry to produce one or more of the following patterns: (i) all on; (ii) clockwise; (iii) counter clockwise; (iv) up-down; (v) lateral; (vi) all pulse; (vii) selected motor pulse; (viii) gradients in frequency; and (ix) gradients in amplitude. The translation of the vibratory pattern and spatial isolation of the motors may produce a desired effect of simulating macroscopic motion without incorporation parts that actually move in macroscopic dimensions. Stiffening members may be added to the motor mounts to vary and/or isolate vibration. The inner surface of the membrane may be textured to transmit vibration to tissue. The flexible membrane reduces or eliminates the coupling of the motor vibration to the device housing and increases or maximizes energy delivery into the tissue.

In one embodiment, patterns are created by multiple vibratory motors. After a motor is activated it can be completely deactivated or have its power reduced such that a pattern of higher power vibration rotates around the array of motors. Rotational patterns, lateral patterns, vertical patterns, and combination thereof can be created by selectively activating and deactivating motors. All such patterns are within the scope of the invention disclosed herein regardless of the number of motors. Further, in embodiments herein in which vibratory motors are depicted as providing the stimulation, other stimulators can be used in place of or in addition to the vibratory motors. That is, one or more of the vibratory motors can instead be an electrical stimulator, temperature stimulator, or other stimulator.

In certain embodiments, multiple vibratory motors create resonance or diphasic amplification. Resonant or diphasic amplification patterns may be advantageous because they may create unique vibratory patterns that would be difficult to achieve with a single vibrating source, and they may create amplification in vibratory power that exceeds the capability of a single motor. Such amplification may be useful in the case of certain electrical power or space constraints. Resonance or diphasic amplification created through the use of multiple vibratory sources may employ different sources including rotary motors, linear motors, and piezoelectrics. The combination of multiple sources may create a large range of customizable and selectable resonant patterns. Further, motors of different sizes and/or power can be used to create multiple resonant frequencies to amplify the vibration effect.

Multiple, isolated and independent motors may combine to produce diphasic amplification or resonant patterns and/or may simulate macroscopic motions. Transitions between motors are smoother with sine wave than square wave. Optimizing the timing and the amplitude of the motion during transition improves the “organic” feel of the stimulation. Preferably, multiple small motors are used to provide easily-differentiated stimulation and simulation of macroscopic motion. Small eccentric motors placed on edge provide a focused vibration point, which promotes differentiation among several vibration sources. Slower vibration transitions promote differentiation among several vibration sources as compared to more rapid transitions.

In certain embodiments, devices provide macroscopic motion in addition to, or instead of, simulating macroscopic motion. In certain embodiments, the controller is designed to map the user's motions on a control surface to the tissue-contacting surface of the stimulating part of the device. By pressing their fingers on the control surface, the user can create various levels of pressure a vibration in the corresponding location on the tissue-contacting surface. As the user moves their fingers across the control surface and optimally desired way, a sequence of motions, pressures, vibrations, and/or stimuli that mimic these actions are created on the tissue-contacting surface. These movements and inputs can be stored either locally on the device or a controller level and played back when desired to create desired effect without requiring the user to repeat their input pattern.

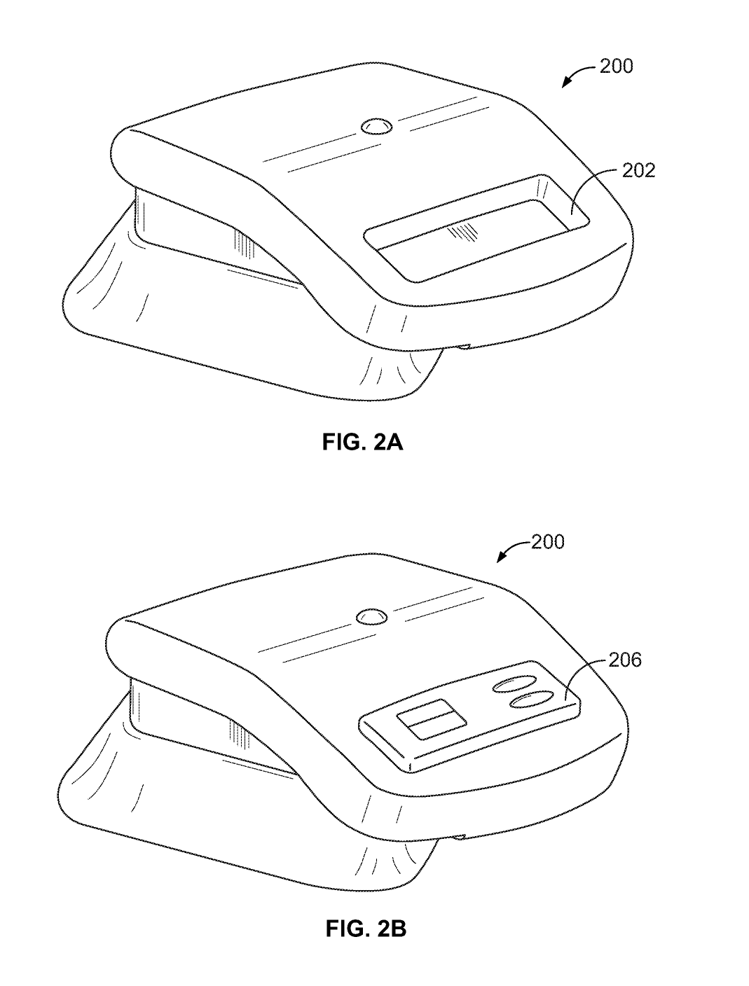

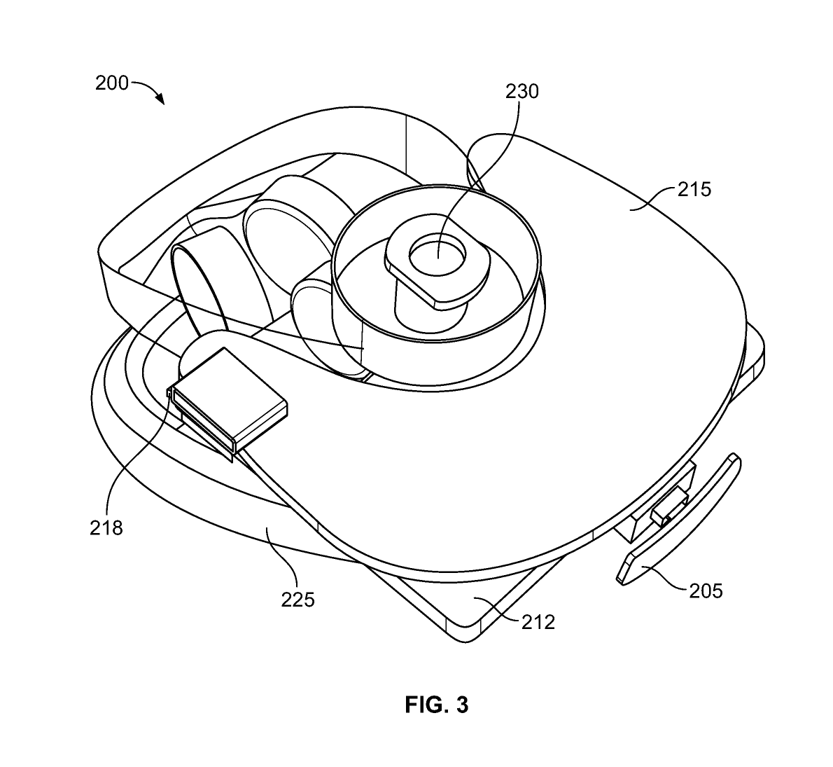

In certain embodiments, a remote controller is a controller configured to send radio-frequency signals to the device worn by the user. The controller may be sized similar to a key fob remote control commonly associated with automobiles. A key fob styled remote can include several buttons capable of controlling the full range of functions of the device discussed herein. FIGS. 2A and 2B illustrate a key fob styled remote controller 206 and device 200, which includes a complementary housing space 202 such that the remote 206 can be docked with the device and housed there when not in use or even when in use. In general, the controller circuitry can include a circuit board, amplifiers, radio antennae (including Bluetooth antennae).

Devices using low power Bluetooth or other radio antennae may experience dropped connections when the remote/device pair is separated by distance or by a physical obstruction (such as a user's or partner's body). In such cases, it is desirable for the device to remain operating under its pre-drop operating conditions while the remote attempts to automatically pair again with the device. Said differently, it is undesirable to require the user or partner to have to manually re-establish the Bluetooth pairing between the remote and the device if the pair connection is lost during device use. And, it is undesirable for the device to cease operating under its existing pre-drop conditions if a pair connection is lost. Thus, certain remotes are configured to automatically re-establish the pair connection with the device without requiring user intervention.

In situations where the remote automatically re-establishes the pair connection with the device, it can be important for the remote to query the device for the current device operating conditions. That is, since the device has maintained a state of operating conditions when the pairing was lost, it is desirable that the remote not interrupt the device operating conditions when the pair connection is re-established. As a counter example, in some Bluetooth pairings, after the pair connection is established the “master’ controller will send a reset signal to the “slave” device. Such a reset would be undesirable in the circumstance where a device is operating under a given set of parameters, patterns, or programs because those parameters, patterns, or programs would be interrupted by the reset signal. Such an interruption could be detrimental to the user experience.

Some of the embodiments of the device deliver suction to engorge and stiffen the tissues and vibration to provide stimulation to the region. In other embodiments, the device delivers suction to engorge and stiffen the tissues and electrical or neural stimulation provides stimulation to the region. In other embodiments, warming or cooling is applied, including light or infrared energy (e.g., near infrared light emitting diodes), instead of vibration or electrical or neural stimulation or in combination with those stimulation types. The stimulation source preferably is in intimate contact with the tissue to optimize energy transfer.

The mounting of the vibration sources may also allow for isolation so that there is spatial differentiation between sources and minimal diffusion of vibratory energy to adjacent structures in the device or tissue. Mounting stimulators on a flexible membrane which travels with the tissue as it becomes engorged with suction may accomplish these goals. However, the membrane should have a direct path between the suction source and tissue—if there is no path the amount of suction delivered will be significantly lower. Placing holes or slits in the membrane may allow for sufficient vacuum and energy transfer. However, holes or slits are placed in the membrane may allow fluid from the tissues to travel through the membrane into the interior vibration source region of the device.

FIG. 3 depicts a view of a device 200 with the outer housing removed. Controller block or circuit 215, which in one embodiment includes subsystem 3220 and processor 3224 thereof, is housed underneath the outer housing and between suction port 230 and activation button 205. The components of controller block 215 can be mounted on one or more printed circuit boards. Activation button 205 is, of course, operably connected to controller block 215 as is I/O port 218. I/O port 218 can plug into an interface cable (or an interface port in a holder) that can be used to program and/or charge the device. Battery 212 is underneath controller block 215.

Miniature coin-style vibratory motors having an eccentric mass are used in certain embodiments. Generally speaking, coin-style motors require larger masses and higher power in order to increase the stimulating force delivered to tissue. Thus, the stimulating force in eccentric motors is a function of mass, and more power is required to drive that mass. In certain embodiments described herein, despite the relatively high mass and relatively high power of the motors the devices can provide spatially-differentiated vibration via the isolation structures and methods described herein. Even when the motors are positioned relatively close together to provide a close fit to the clitoris, embodiments described herein can provide substantial vibrational isolation and provide the user with a spatially-differentiated stimulation experience.

In certain embodiments, modified voice coils are used as the stimulators. As described above, voice coils can achieve high amplitude with low voltage and are smaller size than miniature coin style motors. Voice coils can be modified to include a mass attached to the membrane driven by the electromagnetic field. Advantageously, such mass-bearing voice coils retain the desirable properties of voices coils, including rapid response time, independent control of frequency and amplitude, high acceleration, high precision force control, and relatively low power consumption.

Embodiments of the device may have variable suction controlled by the user or another remote controller. A user may remotely select a pressure and the device will change to that pressure within seconds. The device may include an onboard pump that maintains suction and/or goes up/down from that initial established suction. Certain diaphragm pumps may be used as onboard pumps. Further, the motor driving the diaphragm pump may be used to produce vibratory motion. In certain embodiments, the onboard pump can be a modified voice coil designed to mimic the action of a diaphragm pump. The onboard pump can alternately be made with using a voice coil actuator that moves a membrane in a sealed and valved chamber.

In embodiments using an onboard pump or in embodiments using a remote pump, the suction may be programmed to complement the vibratory motion of the motors or the macroscopic motion of stimulators in the device. The algorithms described herein to drive vibration are adapted to vacuum pump system to provide fast response times and physically differentiable levels of suction to the clitoris. Further, certain embodiments use simultaneous or sequential suction waveforms or algorithms and vibration waveforms or algorithms to amplify the effect of the device.

In some embodiments of the device and method, variations in the stimulation parameters are particularly useful in providing the desired results in a user. For example, the stimulators can be varied between a high power and/or a high frequency level and a comparatively lower power and/or lower frequency setting. In the case of coin cell type stimulators, power and frequency are coupled such that driving the stimulator at higher frequency of oscillation also drives the stimulator at a higher power. To achieve the preferred variations in stimulation, the coin cell type stimulators can be switched between a high power threshold and a low power threshold. In the case of voice coil type stimulators, power and frequency can be decoupled such that a given power of stimulation can be driven at any frequency. Without being bound to a specific mechanism or mode of action, it is believed that comparatively large variations in the power or intensity of the stimulation will produce as desirable user experience.

One of the advantages of embodiments of the invention with multiple stimulators and suction patterns is that different parts of the anatomy can be stimulated at different frequencies. For example, different parts of the frenulum can be stimulated at different frequencies. It is generally understood that different nerve types will be stimulated to a different degree at a given frequency and that different nerves are more fully stimulated at different frequencies. One of the advantages of certain embodiments is the capability of delivering the appropriate frequency and intensity stimulation and/or suction to the different parts of the vaginal anatomy. For example, with the three stimulators positioned as shown the center stimulator primarily stimulates the glans of the clitoris and the right and left stimulators stimulate the right and left crus, respectively, (and/or frenulum) of the clitoris. The device can also enable the user to select and/or tune the desired frequency for their anatomy and nerve distribution, thereby customizing the user experience.

In certain embodiments, it is desirable to release suction during use. For example, the edge of the suction cup could be pulled back, squeezed, or manipulated to create a leak path. Further, a valve in line with the suction tube that can be manually manipulated by the user to release suction. In embodiments using an onboard suction pump, the pump can be configured to include a constant leak path that the pump overcomes—therefore, if the pump stops the device will automatically release. Still further, the device can be configured with a button that the user presses which opens a valve in the pump to release suction. Still further, the valve needed for the suction pump could be normally open. When power is supplied, the valve closes, completing the seal. However, if power goes out, the valve will open and the device will release automatically.

Certain embodiments of the present invention are designed and configured to increase blood circulation in vaginal tissue to promote engorgement to the clitoris and external genitalia while simultaneously applying stimulation to the clitoris and/or other vaginal tissue. The clitoris is a sexual organ that is filled with capillaries that supply blood to a high concentration of nerves. Certain embodiments increase blood flow to stimulate the clitoris and enhance a woman's sexual response.

In women wishing to maintain sexual wellness or be satisfied, methods and devices of certain embodiments can maintain or intensify: (i) genital sensation; (ii) vaginal lubrication; (iii) sexual satisfaction; (iv) sexual desire; and/or (v) orgasm.

Certain embodiments of the invention are designed and configured to be a wearable device designed to increase sexual satisfaction. Certain embodiments of the invention are designed and configured to be used as a “conditioning” product, to prime the user before a sexual event. Certain embodiments can be: used to help a woman prepare her body in advance of a sexual experience, typically with 5-30 minutes of use prior to sex; worn during a sexual experience with a partner, including intercourse; used by a woman alone for recreational purposes to reach orgasm; used as a regime, typically used a few minutes every day, to help facilitate a more intense and pleasurable experience during intercourse with or without a partner; or used over time to help train the body to achieve a better natural sexual response.

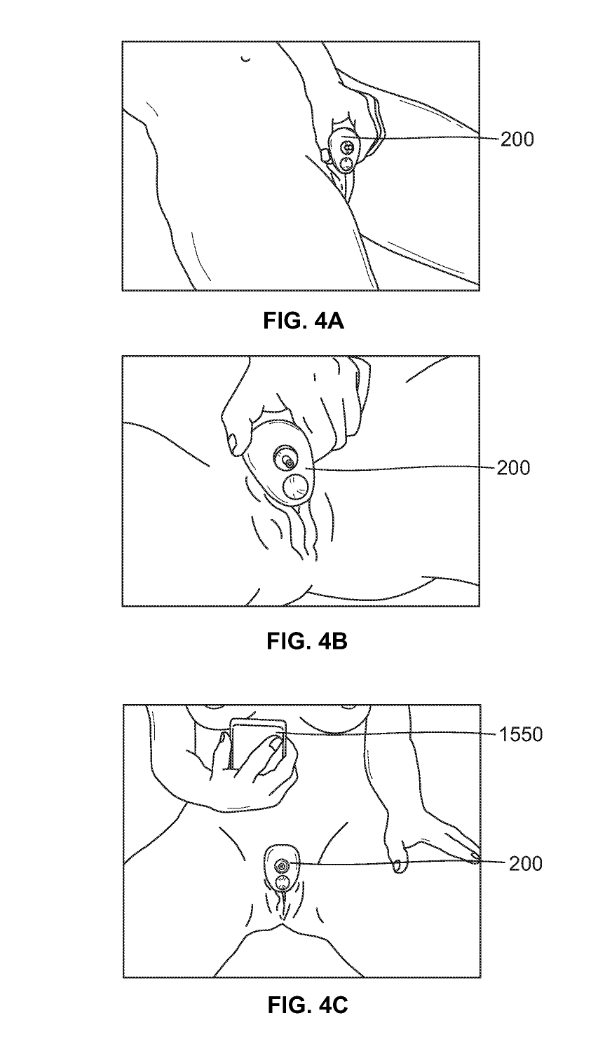

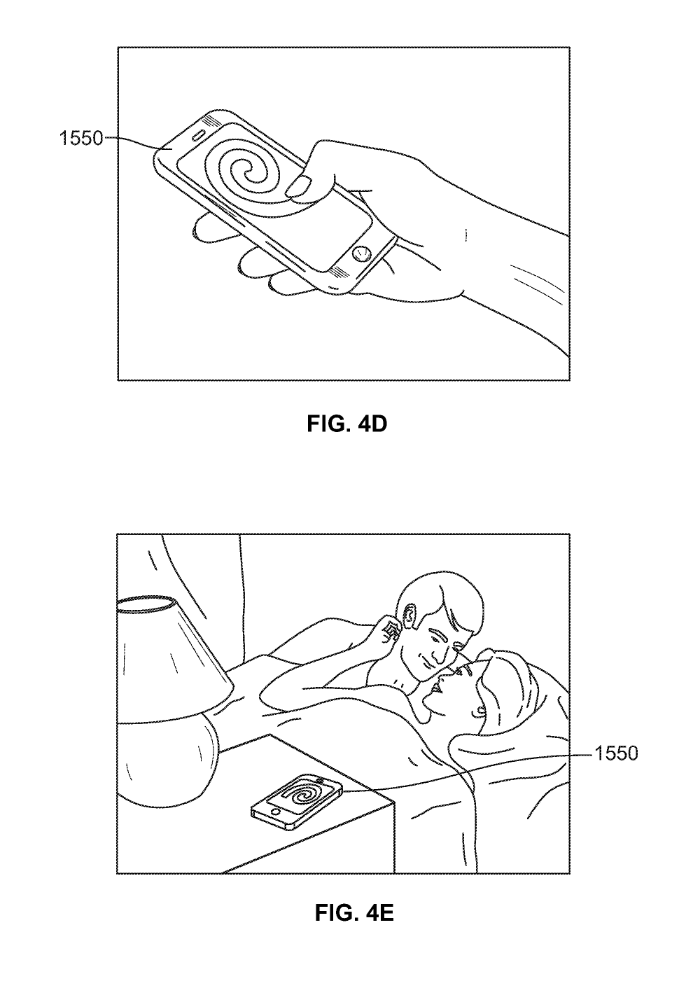

The device 200 is placed over the clitoris (FIGS. 4A-4B) by a woman or her partner. In one embodiment, gentle suction allows the product to stay in place (so it can be completely hands free once placed), although it can be quickly and easily removed as desired. A woman can sit, stand up and walk around while wearing the device 200. As shown in FIG. 4C, a small remote control 1550 or smartphone “app” is used to adjust the device's vibration intensity and unique stroking patterns (such as the counter-clockwise movement pictured in FIGS. 4D-4E). The sequence can be customized in advance and “playlists” can be created. Once in place, the device 200 provides quiet, hands-free sexual stimulation to the clitoral region, working with a woman's body to help improve sexual response. Certain embodiments are small (about 1.5 inches long by about 1 inch wide), quiet, waterproof and discreet. The product is latex-free, hypoallergenic and washable with soap and water. It is quick and easy to place on the body, and can easily be removed. It may be worn under clothing without anyone knowing the user has it on. Since it is a hands-free product, the user can easily move around, stand or walk while wearing the device for a few minutes a day while doing something else to help a woman's body maintain a higher level of sexual responsiveness.

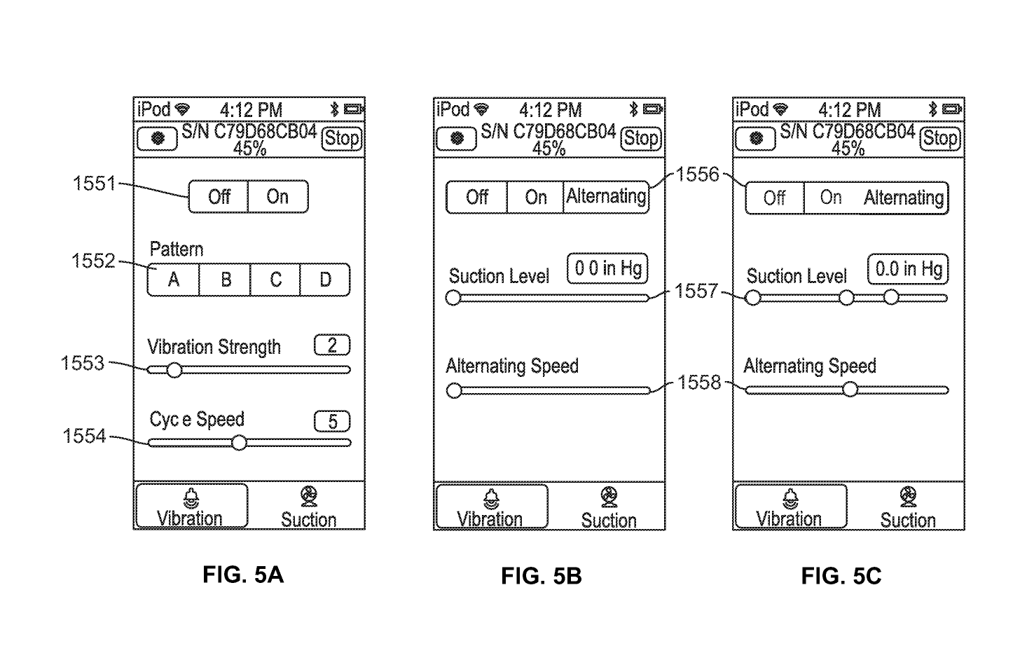

FIGS. 5A through 5C illustrate user interfaces for a smart remote controller 1550. These user interfaces provide means for controlling vibration and suction patterns, including pre-loaded patterns, user-configurable patterns, or combinations thereof. FIG. 44A illustrates a user interface including a vibration on/off button 1551, a vibration pattern selector 1552, a vibration strength selector 1553, and a vibration cycle speed selector 1554. The vibration strength selector 1552 and vibration cycle speed selector 1554 are each shown with a numeric indicator in addition to a slider. The vibration pattern selector 1552 can be loaded with pre-loaded patterns or it can be used to store user-configurable patterns. The user interface provides an intuitive and easy-to-operate means for controlling the vibration and suction patterns of the device.

FIGS. 5B and 5C illustrate a user interface including a suction on/off button 1556, a suction level selector 1557, and a suction alternating speed selector 1558. The suction on/off button 1556 also includes an “alternating” suction setting. FIG. 5B illustrates that when the suction on/off button 1556 is in the “off” or “on” position, the suction level selector 1557 has a single slider point and the suction alternating speed selector 1558 is not available to use. When the user sets the suction on/off button 1556 to “on,” the suction level selector 1557 can be used to set a suction level on the device and that suction level can be numerically displayed in units such as “in Hg.”

FIG. 5C illustrates a user interface in which the suction on/off button 1556 has been set to “alternating.” In the “alternating” mode, the suction level selector 1557 has two slider points and the suction alternating speed selector 1558 is available. The “alternating” mode allows the user to set a primary suction level with the first slider point and a higher suction level with the second slider point. The device can then alternate between these two suction levels at a specific alternating speed that the user sets using the suction alternating speed selector 1558. Thus, the user can control both the difference in suction levels and the speed at which the device alternates between those two suction levels. Further, the user interface can contain a means for the user to store the two suction levels and the suction alternation speed. The user interface can include pre-loaded suction alternation levels and speeds, user-configurable suction alternation levels and speeds, or combinations thereof.

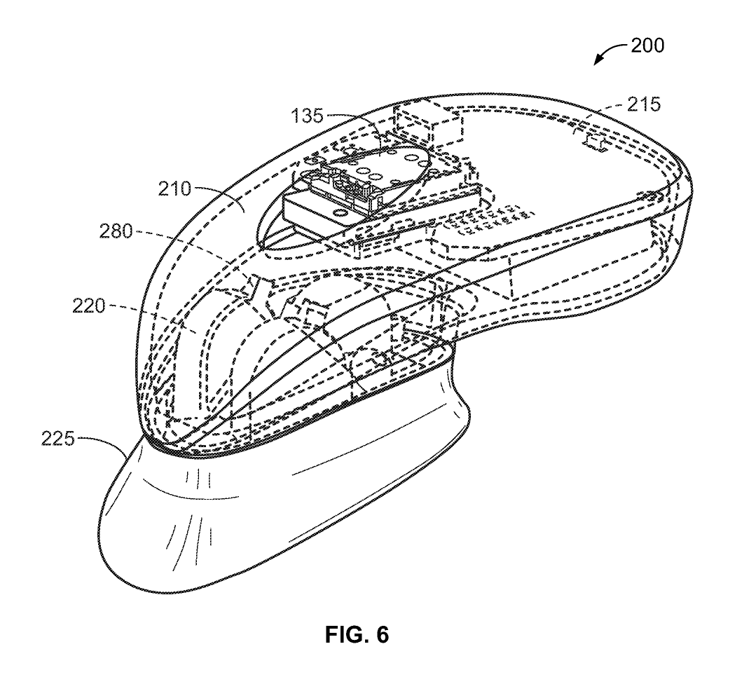

Referring to FIG. 6, the device body 210 of device 200 is illustrated to provide a view of the interior of the device body 210. At least one, and in one embodiment a plurality of, suitable active stimulators 280 are carried by device 200. In one embodiment, the active stimulators 280 are three vibratory motors 280 provided in device 200 and arranged in a triangular configuration within suction chamber 220, as shown for example in FIGS. 1C and 3. The one or more vibratory motors 280 are positioned within structures in single molded piece 220 such that the stimulation from the motors can be efficiently propagated to tissue, and portions of the vibratory motors 280 are also accessible to be connected to controller block 215. In this case, controller block 215 is illustrated as a printed circuit board. An onboard pump 135 is also positioned within device body 210. The onboard pump 135 is in fluid communication with the suction chamber to provide suction within that chamber and is also in fluid communication with an exhaust port. The exhaust port is an outlet for air or fluid pumped out of the suction chamber and an inlet for air to the suction chamber when suction is reduced. In some embodiments, the onboard pump 135 sends air pumped from the suction chamber across heat-generating elements within the device body 210 before reaching the exhaust port. Such airflow can help dissipate heat and provide safe and reliable use of the device.

In some embodiments, heat generation in the device can be monitored using a component such as a thermistor or other suitable temperature sensor. The one or more temperature sensors or thermistors can be positioned within the device body 210 or be integral to the controller block 215. When the thermistor detects a threshold temperature, it can turn off power to the device and/or vent external air into the device to help the cool the device and then release suction.

In some embodiments, the onboard pump is controlled by the controller block via a closed feedback loop. That is, the controller block is configured to maintain a target pressure, which can be set by the user or can be loaded as part of a pre-programmed suction algorithm.

To do so, the controller block reads real-time data from an onboard pressure sensor that is configured to monitor pressure (negative pressure in the case of suction) within the suction chamber. Based on the real-time data, the controller block can engage the onboard pump to draw more suction within the suction chamber or it can engage a check valve in fluid connection with the exhaust port to vent air into the suction chamber. In typical operation, after the device has generated sufficient suction to seal it in place on the user the controller block with periodically engage the onboard pump as suction is slowly lost through leakage.

Certain embodiments of the invention include device and methods to maintain or intensify female sexual wellness and female sexual pleasure. The methods naturally enhance a woman's own sexual response. A woman will enjoy sexual intimacy and feel confident in her body's ability to respond to sexual stimulation.

In certain embodiments, the system includes a vacuum reservoir. That is, the system includes a chamber that is capable of holding negative pressure that can be applied to the suction chamber of the device through a valve system. During initial attachment, after achieving the desired level of suction in the suction chamber, such as with an on-board pump, the vacuum source continues to run to supply the vacuum reservoir with excess negative pressure. The on-board pump can stop running, and if a small leak develops the negative pressure in the vacuum reservoir can supply suction to the suction chamber until it is exhausted, and then the pump can turn back on to replenish the reservoir and suction chamber and then stop running again. One advantage of the vacuum reservoir is that the desired level of suction can be maintained while having the suction source operate comparatively less than a system without a vacuum reservoir.

Systems described herein can be equipped with sensors and sensing capabilities. The data collected from sensing can be used in a variety of ways, such as display to the user and/or feedback to the device control systems. Sensed parameters include tissue temperature, tissue impedance, blood flow, tissue turgidity and/or engorgement, heart rate, and blood pressure. The data can be represented on the user control device, such as a smartphone. The data can be represented graphically and/or numerically and can be mapped over a visual representation of the anatomy. In a sense, the displayed data can be an “arousal meter” that provides information to the user. Further, the state of the user's arousal can be used to provide a biofeedback loop to control the device. For example, the user can set an arousal level on the device prior to use and the device can monitor the user's arousal state. By sensing the arousal state, the device control systems can increase or decrease stimulation to meet the user-set state.

In many of the embodiments described herein, it can be desirable to apply therapeutic energy to clitoral and/or vulvar tissue, such as light energy or electromagnetic energy. Certain light frequencies can decrease tissue inflammation and certain light frequencies can increase local blood flow.

In many of the embodiment described herein, it can be desirable to provide ambient sounds via the device or system. Ambient sounds can be soundscapes that promote feelings of well-being and/or arousal in the user. Additionally, the ambient sound can be a “white noise” that provides a relatively constant background sound and thereby masks or de-emphasizes sounds made by the device during device operation. To that end, the device or system could include an active noise cancellation system.

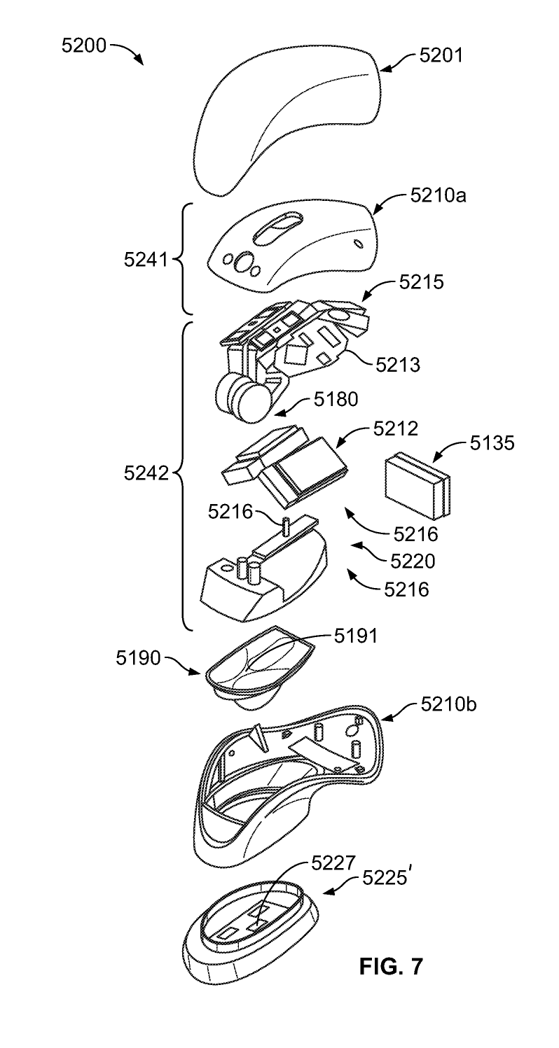

FIG. 7 depicts an exploded view of a device 5200 according to aspects of the invention. In one embodiment, device 5200 is substantially similar to device 200. Device 5200 includes a housing, and in one embodiment a suction chamber, a pump, at least one sensor, at least one active stimulator and a controller are carried by the housing. The controller can be electrically coupled to the pump, the at least one sensor, the at least one active stimulator or any combination of the foregoing for controlling the operation thereof. A cover 5201 can be affixed to upper device body 5210a. The cover 5201 includes cosmetic features, giving the device visual and tactile appeal. For example, the cover 5201 can be formed from a thermoplastic elastomer, a thermoplastic polyurethane, a silicone polymer, or combinations thereof. The cover 5201 can have various surface textures, including a matte-style texture or other “soft-touch” textures. The cover 5201 can be formed with various patterns and colors, including liquid film printing on the inside surface of the cover 5201 to provide visually pleasing color depth. Of course, other finishes including glossy finishes, slick textures, grippy textures and many others are possible for cover 5201. In some embodiments, the cover 5201 can be a comparatively rigid part, including having rigidity comparable to the rigid parts of the device body.

The cover 5201 can also provide a seal for the assembled device body, which consists of the device body cover 5210a and lower device body 5210b. The device body cover 5210a is configured to attach with the lower device body 5210b and together they form a device body that contains device components, which can include a pump 5135, a controller block 5215, and one or more batteries 5212. The pump 5135 can be coupled to suction housing 5220, and in one embodiment the pump 5135 is secured to the suction housing 5220 by any suitable means such as one more suitable fasteners such as screws 5216. One or more temperature sensors 5241, which can be thermistors, can be provided in device 5200 for measuring ambient or atmospheric temperature during the operation of device 5200. In one embodiment, at least one temperature sensor 5241 is provided under cover 5201 or on or under device body cover 5210a and is electrically connected to controller block 5215, as shown schematically in FIG. 7. The components housed between the device body cover 5210a and the lower device body 5210b are moisture sensitive. Thus, the cover 5201 should provide a fluid tight seal for the assembled device body. Both the device body cover 5210a and the lower device body 5210b can be formed by various methods, including injection molding, and from suitable materials, such as polycarbonate. The components housed inside the assembled device body include a controller block 5215, which in FIG. 7 is depicted as a custom shape formed of printed circuit boards and associated flexible circuit boards 5213.

One or more active stimulators 5180 or any suitable type can be included in device 5200 for stimulating the clitoris of the user during operation of the device 5200. The stimulators can be carried by the device in any suitable manner, and in one embodiment at least a portion of each of the one or more stimulators extend into suction chamber 220 so as to be positioned over the glans of the clitoris of the user, centrally, and over the crura of the clitoris, laterally, during use of the device 5200. In one embodiment, each of the active stimulators is flexibly suspended by the device 5200, for example from the inside of the device. In one embodiment, one or more active stimulators 5180 can be soldered or otherwise secured to an arm of flexible circuit board 5213 that can be wrapped around a circular edge of the stimulator 5180. The flexible circuit board 5213, the flexible membrane 5190 or both can serve to flexibly suspend the active stimulators 5180 to the device 5200. The flexible suspension of the active stimulators 5180 allows the stimulators to move with the clitoris during stimulation of the clitoris. For example, the active stimulators 5180 can move as the clitoris may expand or contract during use so as to continue stimulation of the clitoris despite such expansion or contraction.

Still referring to FIG. 7, a suction housing 5220 is shown as fitting between the device body cover 5210a and the lower device body 5210b. The suction housing 5220 is sealed against the lower device body 5210b to form a vacuum tight seal. The suction housing 5220 forms the upper boundary of a suction chamber for stimulating tissue. The batteries 5212 can be placed between the upper surface of the suction housing 5220 and the controller block 5215. The active stimulators 5180, which in one embodiment are vibratory motors such as vibratory motors 280, are located underneath the suction housing 5220 and positioned within the motor membrane 5190. In this regard, a portion of each of the active stimulators 5180 is accessible through the suction housing 5220 so as to be connected to controller block 5215. In one embodiment, three active stimulators or vibratory motors 5180 are provided, and one stimulator or motor is glued into a respective one of three pockets or protrusions 5191 provided in motor membrane 5190. Each of the pockets or protrusions, housing the active stimulators 5180, extend into the suction chamber 220. Motor membrane 5190 is a flexible membrane and in one embodiment is a fluid-tight barrier between the active stimulators 5180 and the user's tissue.

One or more temperature sensors 5242, which can be thermistors, can be provided in device 5200 for measuring the temperature of the active stimulators 5180 in the vicinity of where the stimulators 5180 engage the tissue of the user. In one embodiment, at least one temperature sensor 5242 is provided for each of the plurality of three active stimulators 5180. One such temperature sensor 5242 is shown schematically in FIG. 7 and in FIG. 1C. In one embodiment, one or more of the temperature sensors 5242 can be mounted on the flexible portion of circuit board 5213 that is wrapped around the respective active stimulator 5180. In one embodiment, one or more of the temperature sensors 5242 can be mounted on the motor membrane 5190 or on lower device body 5210b, for example in the vicinity of where the respective active stimulator 5180 engages the tissue of the user. When fully assembled, the lower portions of the motor membrane 5190 are in contact with the motor recesses 5227 of the removable flange assembly 5225′. In one embodiment, the three pockets or protrusions of the motor membrane 5190 sit in the three respective pockets or motor recesses 5227 of removable flange 5225. The motor membrane 5190 and removable flange assembly 5225 are each thin membranes between the active stimulators 5180 and the tissue of the user.

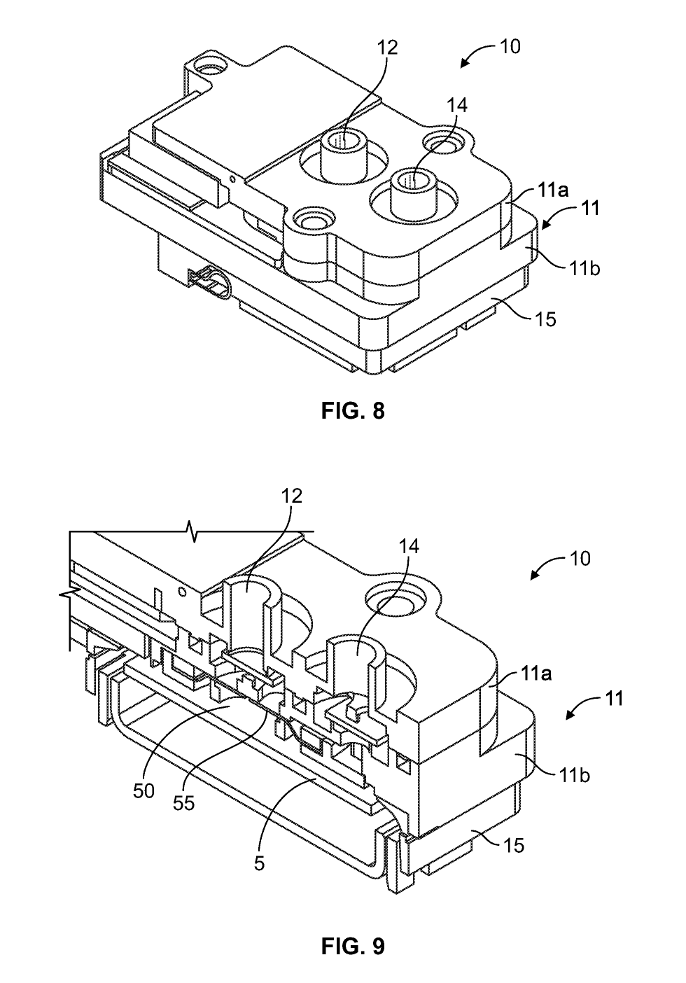

Pump 5135 can be of any suitable type and in one embodiment is a miniature pump. A particular miniature pump is illustrated in FIGS. 8-22B, where FIG. 8 illustrates a perspective view of a miniature pump 10, which includes inlet port 12 and outlet port 14. The miniature pump 10 includes pump body 11, which can be a single piece or can be formed from multiple pieces. In FIG. 8, the pump body 11 includes upper body 11a and lower body 11b. The miniature pump 10 also includes actuator 15. Preferably, the actuator 15 is an electromagnetic voice-coil type actuator such as those commonly used in mobile phones and other electronic devices.

FIG. 9 illustrates a cross-section of the perspective view of FIG. 8 of the miniature pump 10. FIG. 9 illustrates the diaphragm assembly 50, which includes diaphragm 55. FIG. 9 also illustrates the actuator membrane 5 on the upper surface of the actuator 15. The actuator membrane 5 is coupled to the diaphragm assembly 50 and drives the motion for the miniature pump to function.

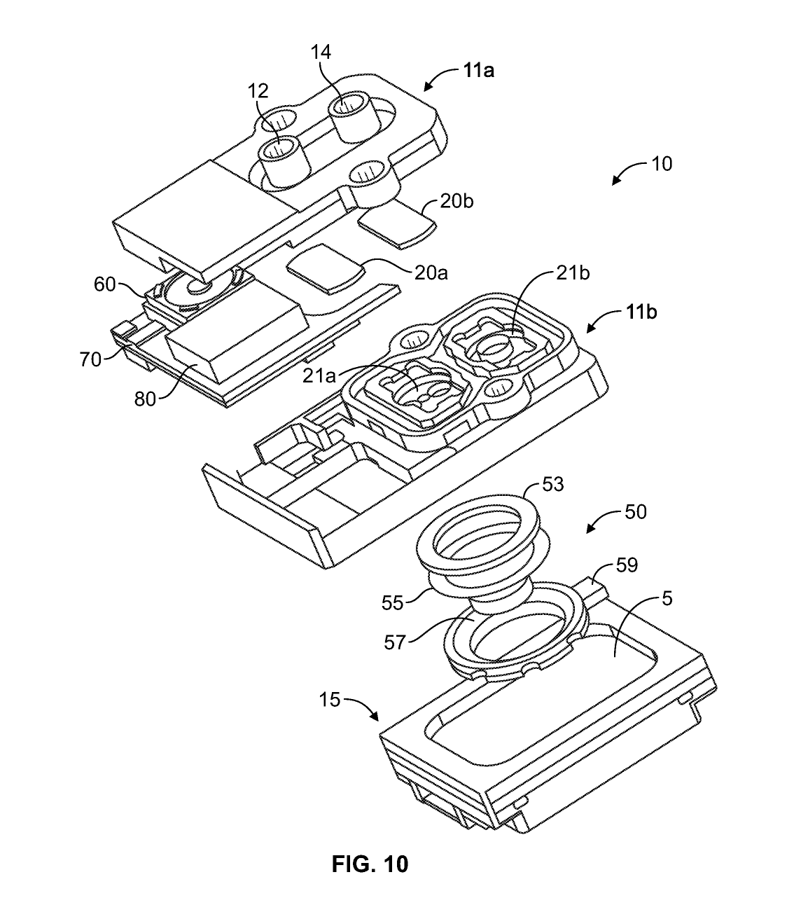

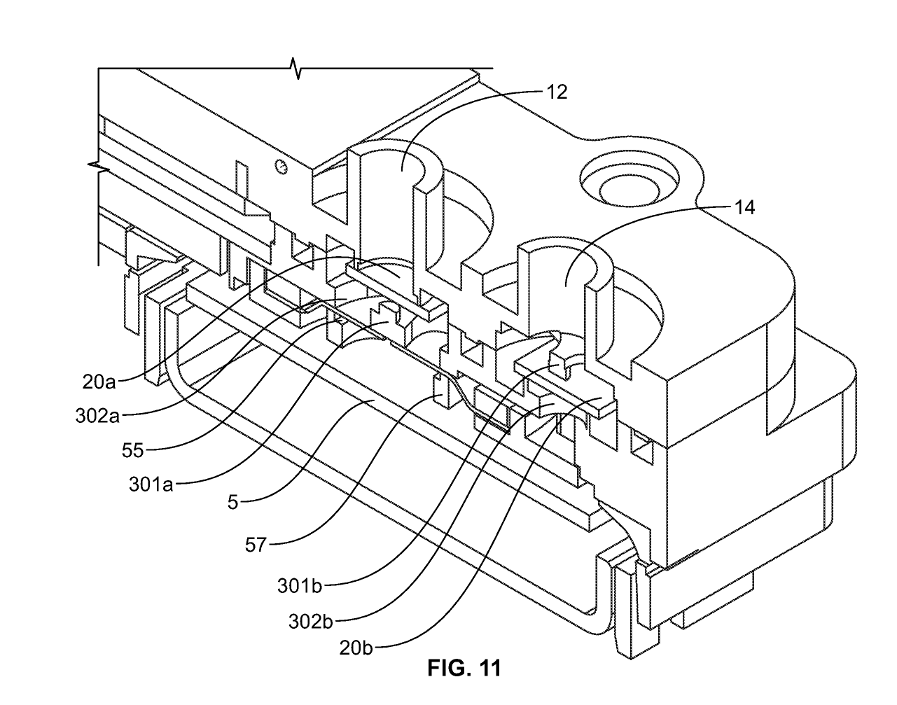

FIG. 10 illustrates an exploded perspective view of the miniature pump 10. FIG. 10 illustrates the diaphragm assembly 50 as including upper spacer 53, diaphragm 55, magnet 57, and housing 59. The upper spacer 53 helps define the upper portion of the pumping chamber in which the diaphragm 55 reciprocates. The upper spacer 53 may alternately be a component, such as a molded component, of the lower pump body 11b. The magnet 57 is attached to the lower surface of diaphragm 55 and also attached to the upper surface of the actuator membrane 5. The housing 59 is attached to the lower surface of the lower pump body 11b. The spacer 53 is configured to fit within the inner circumference of the upper section of housing 59. The outer edges of the diaphragm 55 are sandwiched between the lower surface of the spacer 53 and the upper surface of the inner ring of housing 59 such that the spacer 53 and the housing 59 cooperate to keep the outer edges of the diaphragm 55 fixed. The edges of the diaphragm 55 are held fixed while the inner portion of the diaphragm 55 is able to reciprocate up and down, and the diaphragm 55 thereby acts as the volume displacement mechanism of the miniature pump 10. The components that make up diaphragm assembly 50 should be joined in a fluid-tight and/or air-tight manner.

FIG. 10 illustrates the lower pump body 11b, which can be a molded part that incorporates many of the flow-paths and flow-control features of the miniature pump 10. For example, the inlet valve recess 21a is configured to accept the inlet valve 20a and the outlet valve recess 21b is configured to accept the outlet valve 20b. Also within lower pump body 11b are openings and ports configured to complement the valve and diaphragm arrangement and allow for controlled flow of gas or liquid through the lower pump body 11b.

FIG. 10 illustrates a control board 70, a blow-off valve 60, and a sensor 80, all of which can be housed in recessed areas within the pump body. In FIG. 10, both the upper pump body 11a and the lower pump body 11b include features configured to house the control board 70, the blow-off valve 60, and the sensor 80.

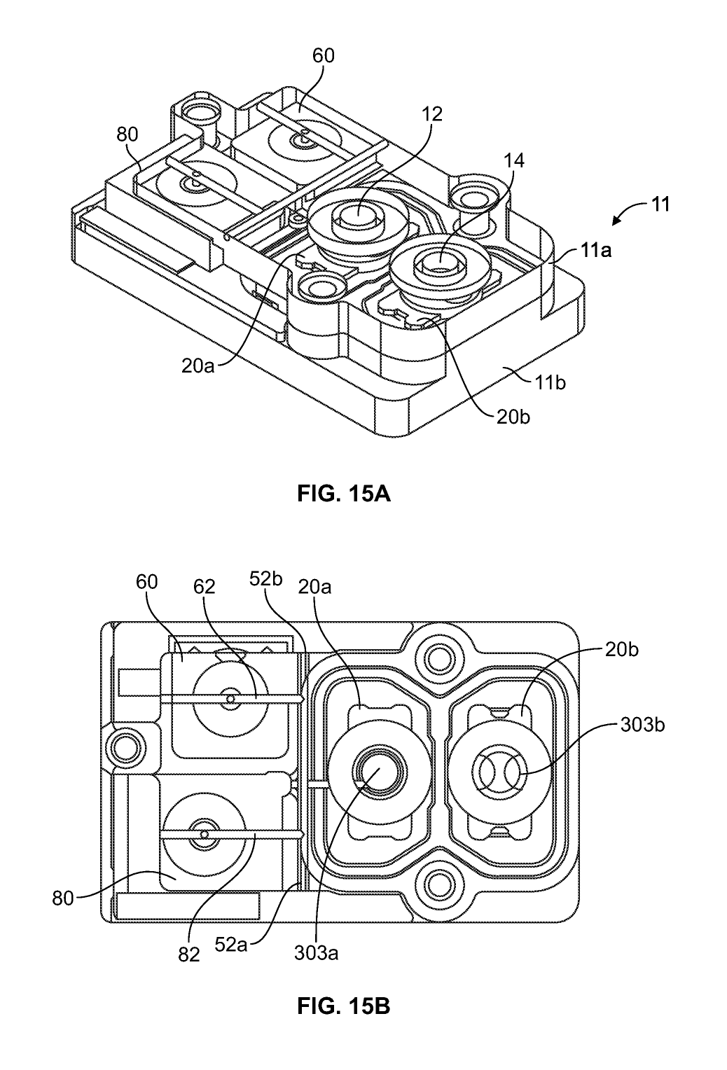

Generally speaking, the operation of the inlet valve 20a and the outlet valve 20b is similar to a positive displacement diaphragm pumps. That is, when the diaphragm is withdrawn away from the inlet port 12, the inlet valve 20a is also drawn away by negative pressure from upper inlet chamber port 302a and engages against inlet port offset 301a. This movement creates a flow path down through the inlet port 12, through the upper inlet chamber port 303a (see FIG. 15B), across the inlet valve 20a, and down through the lower inlet chamber port 302a. The negative pressure also draws the outlet valve 20b into sealing engagement with the lower outlet chamber port 302b, which seals the outlet chamber and prevents flow through to the outlet 14.

When the diaphragm 55 begins its return stroke towards the inlet port 12, positive pressure forces the inlet valve 20a away from the inlet port offset 301a and into sealing engagement with the upper inlet chamber port 303a. The positive pressure also forces the outlet valve 20b away from the lower outlet chamber port 302b and into engagement with the outlet port offset 301b. This movement creates a flow path from the diaphragm chamber, through the lower outlet chamber port 302b, across outlet valve 20b, through upper outlet chamber port 303b (see FIG. 15B) and out through outlet 14.

FIG. 11 illustrates a close up view of the cross-sectional view of FIG. 9. In FIG. 11, the inlet valve 20a is depicted in its closed position such that its upper surface is sealingly engaged against upper inlet chamber port 302a and the outlet valve 20b is depicted as engaged against the outlet port offset 301b. Further, outlet valve 20b is depicted as disengaged from lower outlet chamber port 302b.

The valves are sized and configured to be movable by the range of pressure expected from the use environment of the miniature pump 10. For example, the valves should have a weight to surface area ratio such that they are movable by the flow of liquid or gas when the miniature pump is in use. Further, the valves are made of a material that enables the valves to sealingly engage against their respective ports when moved into such as sealing position by liquid or gas flow. Rubber is one example of a suitable material for making valves in such a miniature pump.

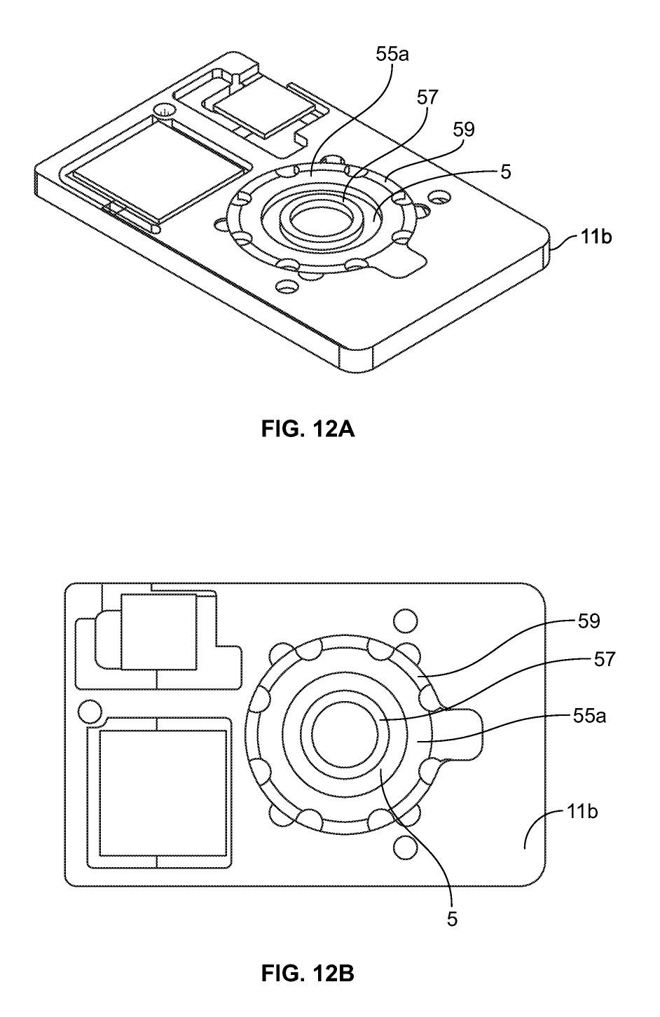

FIGS. 12A and 12B illustrate a perspective view and a plan view, respectively, of a cross-section of a portion of a miniature pump 10 according to certain embodiments. FIGS. 12A and 12B illustrate the housing 59 engaged with a section of lower pump body 11b. A portion of the diaphragm is shown as engaged to housing 59 and labeled with the reference 55a. Actually, the diaphragm 55 spans the housing 59 and in this perspective view would obscure the magnet 57 from view. For the purposes of these views, only a portion of the diaphragm 55 is shown. The magnet 57 is attached to the actuator membrane 5.

When known diaphragm displacement pumps are connected to a closed chamber in order to pull vacuum on such a chamber, each pump stroke requires successively more energy than the last stroke as the pressure difference across the diaphragm increases. That is, the greater the vacuum in the closed chamber, the more difficult it is for the diaphragm to travel a full stroke. Generally, pumps are driven with more power in order to generate longer pump strokes under higher vacuum conditions.

In contrast, pumps according to certain embodiments do not require as much of an increase in power to generate longer pump strokes under higher vacuum conditions because these miniature pumps are loaded on the exhaust stroke. In contrast to previously known positive displacement diaphragm pumps, the miniature pump 10 includes the magnet 57, which functions to load the pump stroke of the miniature displacement pump during the exhaust stroke. The actuator membrane 5 can be driven using a sinusoidal signal such that the actuator membrane 5 reciprocates between an upper position and a lower position. Since the actuator membrane 5 is attached to the diaphragm 55, the reciprocation of the actuator membrane 5 causes a similar reciprocation of the diaphragm 55. When the actuator membrane 5 and diaphragm 55 reciprocate away from the pump body 11, the diaphragm motion is expanding the size of the diaphragm chamber and drawing gas or liquid within the chamber in a pump stroke. When the actuator membrane 5 and diaphragm 55 reciprocate toward the pump body 11, the diaphragm motion is contracting the size of the diaphragm chamber 54 in an exhaust stroke. The inlet valve 20a and the outlet valve 20b are, of course, moving in concert with such pump strokes and exhaust strokes to allow gas or liquid to flow one way through the miniature pump from the inlet to the outlet.

The actuator 15 can be an electromagnetic, which includes an electromagnetic drive element coupled to the actuator membrane 5. Such a voice coil actuator performs essentially like a loudspeaker, such that waveform signals sent to the electromagnetic drive element drive the actuator membrane in a pattern generated by the waveform.

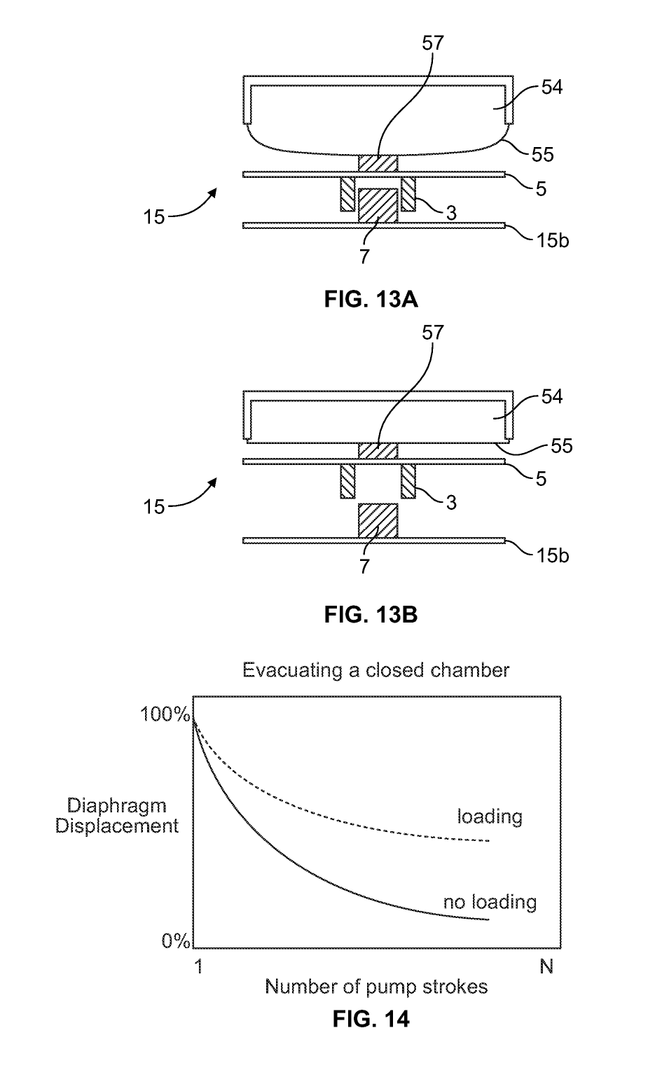

FIGS. 13A and 13B illustrate schematics of the mechanism of interaction between the actuator and the diaphragm. The actuator 15 includes an actuator base 15b, an actuator membrane 5, an actuator pole magnet 7, and actuator coil 3. Actuator pole magnet 7 can be alternatively referred to as a magnet or voice coil magnet. The actuator pole magnet 7 is fixed to the actuator base 15b. The actuator coil 3 is fixed to the underside of the actuator membrane 5. The magnet 57 is a permanent magnet and is fixed to the upper surface of the actuator membrane 5 and to the underside of the diaphragm 55. In some cases, the position of the magnet 57 is adjustable up and down with respect to the actuator membrane 5, but in FIGS. 13A and 13B it is depicted as fixed to the actuator membrane 5.

During the pump stroke, electric current is applied to the actuator coil 3 to create an electromagnetic field that attracts the actuator coil 3 to the actuator pole magnet 7. The actuator coil 3 is fixed to the actuator membrane 5, which is connected to the diaphragm 55. Thus, the diaphragm 55 is pulled away from the diaphragm chamber 54, thereby increasing the volume of the chamber and drawing air or liquid through the inlet valve and into the diaphragm chamber in a pump stroke.

Referring still to FIGS. 13A and 13B, the magnet 57 is oriented to be magnetically attracted to the actuator pole magnet 7. During the pump stroke when the diaphragm 55 is pulled away from the diaphragm chamber 54, the magnetic attraction between the magnet 57 and the actuator pole magnet 7 helps pull the diaphragm 55 and the actuator membrane 5 more fully back towards the actuator pole magnet 7 than if the magnet 57 was not present in this position. This is especially helpful at high suction where the diaphragm 55 would not ordinarily be able to travel as far downward because of the pressure drop across the diaphragm 55. That is, at low levels of negative pressure in the diaphragm chamber 54, there is low resistance to pulling the diaphragm 55 away from the diaphragm chamber 54. At such low levels of negative pressure, the electromagnetic force generated by low power in the actuator coil 3 is sufficient to drive the pump stroke. However, at higher levels of negative pressure in the diaphragm chamber 54, there is higher resistance to pulling the diaphragm 55 and therefore higher power would be required. The magnet 57 is helpful in this context because it adds magnetic force to pull the diaphragm 55 down without requiring additional power since the magnet 57 is a permanent magnet.

FIG. 13B depicts the exhaust stroke, in which electric current is applied to the actuator coil 3 to create an electromagnetic field that repels the actuator coil 3 from the actuator pole magnet 7. Repelling the actuator coil 3 forces or urges the actuator membrane 5 and the diaphragm 55 towards the diaphragm chamber 54, which reduces the volume of the diaphragm and drives air or liquid through the outlet valve in an exhaust stroke. During this exhaust stroke, the magnet 57 is also pushed away from the actuator pole magnet 7. That is, the electromagnetic force is sufficient to repel the actuator coil 3, and all the components fixed to it (such as the actuator membrane 5, the magnet 57, and the diaphragm membrane 55) away from the actuator pole magnet 7.

Advantageously, the magnet 57 is moved away from the actuator pole magnet 7 during the exhaust stroke. This is an advantage because the diaphragm 55 encounters comparatively low resistance during the exhaust stroke as gas or liquid is displaced from the diaphragm chamber 54. Thus, the exhaust stroke separates the permanent magnet 57 from the actuator pole magnet 7 with relatively low additional power requirement than if the magnet 57 was not on the diaphragm 55. Then, during the pump stroke, the separation between the magnet 57 from the actuator pole magnet 7 provides additional magnetic force as described above. As a result, the miniature pump is able to operate more efficiently at low power than a conventional electromagnetic diaphragm pump.

FIG. 14 is a graphical depiction of an efficiency comparison between a miniature electromagnetic diaphragm pump using an additional “loading” magnet, such as permanent magnet 57 above, according to an embodiment of the invention and an electromagnetic diaphragm pump without a loading magnet. This graph plots the physical displacement, or stroke length, of the diaphragm as a function of the number of pump strokes as the electromagnetic pump is used to evacuate a closed chamber. Further, this graph assumes that the pumps are driven at a generally constant power, although the benefit of the loading magnet is not limited to constant power applications. Because the pumps in the graph are evacuating a closed chamber, the pressure difference across the diaphragm increases with each pump stroke as the negative pressure increases inside the closed chamber. While the loaded and the unloaded diaphragm both travel at or near their full displacement during the initial pump strokes, the efficiency of the pumps diverges as negative pressure increases. The unloaded diaphragm (labeled as “no loading”) has a rapidly diminishing pump stroke such that it becomes comparatively inefficient at higher pump strokes. The loaded diaphragm, in contrast, is able to be physically displaced to a greater degree in this constant power application because of the passive magnetic loading force of the permanent magnet fixed to the diaphragm.

The relative strength of the magnetic forces among the actuator components (i.e., the electromagnetic coil and the pole magnet) and the diaphragm or permanent magnet can be used to tune the efficiency of the miniature pump. For example, a stronger diaphragm magnet will provide more loaded energy to the pump stroke of the diaphragm when separated from the pole magnet, but will also require more power to be separated during the exhaust stroke.

In some embodiments, the diaphragm magnet is fitted with an adjustment mechanism that allows the separation between the diaphragm magnet and the pole magnet to be varied. For example, the diaphragm magnet could be housed within a recess fixed to the upper surface of the actuator membrane. The diaphragm magnet could rest atop a tapered adjustment screw such that when the screw is turned one direction the magnet moves closer to the actuator membrane and when the screw is turned the opposite direction the magnet moves farther from the actuator membrane.

Advantageously, magnetic fields are sensitive to distance. The strength of the magnetic field between the two permanent magnets (the actuator pole magnet and the diaphragm magnet) can decay following the inverse cube of the distance from the source. That is, if D is the distance between the magnets and F is the strength of the forces, then F=1/D³. This is advantageous for embodiments of the invention because the force is much higher when the permanent magnets are closer, such as at the maximum displacement of the diaphragm during the pump stroke. And, the force is much lower at the minimum displacement of the diaphragm during the exhaust stroke. The loaded miniature pump designs of embodiments of the invention can operate with significantly more efficiency than unloaded pump designs because of this inverse relationship between force and distance.

In accordance with some embodiments, the miniature pump preferably is about 12 to 20 mm long, about 10 to 15 mm wide and about 3 to 9 mm high, more preferably about 18 mm long, about 12 mm wide and about 7 mm high. The mass is preferably about 1 to 5 grams, more preferably about 3 grams. The miniature pump preferably operates with a voltage between about 3.5 to 5 volts, peak current when running of about 100 to 200 mA, and standby current of about 20 to 40 mA. The miniature pump is self-priming and preferably is less than about 90 dB two inches away, more preferably, less than about 70 dB two inches away. The miniature pump preferably has a peak suction of about −6 in Hg, more preferably about −8 in Hg. The suction rate is preferably about 0 to −6 in Hg in less than about 10 seconds with 10 mL volume of air, more preferably about 0 to −8 in Hg in less than about 10 seconds with 10 mL volume of air.

FIGS. 15A and 15B illustrate a perspective view and a plan view, respectively, of a cross-section of a portion of the pump body 11 according to certain embodiments. In these views, upper channel 52a and lower channel 52b are in fluid connection from the diaphragm chamber to the blow-off valve 60 and the sensor 80. The valve channel 62 and the sensor channel 82 are in fluid connection with upper channel 52a. These channels allow for monitoring and control of the pressure in the diaphragm chamber via the sensor 80 and the blow-off valve 60. The pressure measured by sensor 80 can approximate the pressure in suction chamber 220. In one embodiment, the pressure measured by sensor 80 can be less than one inch of mercury different than the pressure in suction chamber 220. In one embodiment, the pressure measured by sensor 80 ranges from about 0.50 to about 0.75 inches of mercury different than the pressure in the suction chamber 220. The channels can be designed as part of the molded pump body 11 sections, can be drilled into the pump body 11 after molding, or can be tubes or other conduits that are included in an overmolding step or during assembly of the pump body.

The blow-off valve 60, the sensor 80, and the control board 70 work together in a closed loop control system for monitoring and adjusting the performance of the miniature pump. In one example, the closed loop control systems can be programmed to maintain a level of negative pressure within the diaphragm chamber. That is, the sensor continuously monitors the pressure level in the diaphragm chamber and provides that data to the control board. The firmware (or software) on the control board can compare the data to the programmed pressure level and then send power to the actuator to drive the miniature pump to increase the pressure or send a signal to the blow-off valve to release negative pressure. In another example, a pre-programmed or user-selected suction profile can be generated using the closed loop control system. That is, rather than seeking a set level of negative pressure, the closed loop control system seeks a time-dependent pattern of pressure levels by continuously comparing the negative pressure level in the diaphragm chamber with the time-dependent level specified in the profile. The blow-off valve or the pump can then be activated as needed.

In another example, the closed loop control system can help optimize the efficiency of operation and reduce noise levels. In this example, the firmware uses a look-up table to find optimal operating conditions for the miniature pump at a given level of negative pressure. At a given pressure the miniature pump may operate most efficiently at a certain power signal profile. That is, a particular shape of the signal waveform (e.g., the amplitude and frequency of a sinusoidal signal) may allow the miniature pump to operate more quietly than another similar shape at a given pressure. Generally, noise in the miniature pump is generated by the diaphragm hitting the walls of the diaphragm chamber and by the valves hitting the walls of their valve recesses and offsets. By calibrating the position of the diaphragm and valves at given power levels and pressure levels and cross-referencing those positions against power and pressure levels in a look-up table accessible to the firmware, the miniature pump can be operated in a way that reduces or eliminated valve and/or diaphragm noise. Further, reducing or minimizing diaphragm and valve noise increases the efficiency of the miniature pump since less energy is lost to the pump body through collisions between the valves and/or diaphragm and the pump body.

Another advantage of the closed loop control system is that the blow-off valve can be activated under certain conditions. For example, if the negative pressure exceeds a certain level, the firmware can activate the blow-off valve to allow air into the diaphragm chamber. As another example, if the valve temperature rises above a certain level (as detected by a temperature sensor integrated into the miniature pump and in communication with the control board), the firmware can activate the blow-off valve.

Generally, the control and sensing components of the miniature pump can reside within the pump housing or can be remote from the pump. That is, a processor and sensor can be located away from the actual pump body and still be able to provide the sensing and control features described herein. Also, the blow-off valve maybe located remotely from the pump body provided it has the fluid connection necessary to provide the pressure relief performance. Thus, the closed loop feedback system can exist in a system of physically separate components that are functionally interconnected.

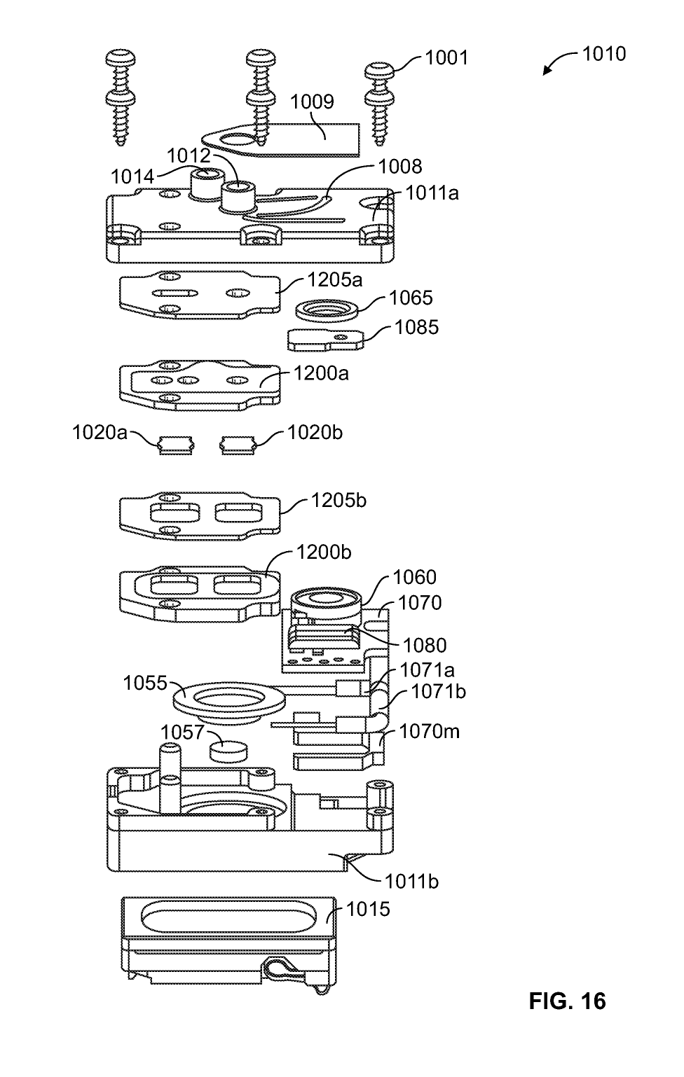

FIG. 16 illustrates an exploded perspective view of an embodiment of a miniature pump 1010 that may be utilized in the device of the invention. The miniature pump 1010 includes an actuator 1015, which can be an electromagnetic voice-coil type actuator such as those commonly used in mobile phones and other electronic devices. Attached to the actuator 1015 is the lower body 1011b, which contains the diaphragm assembly as described previously herein. FIG. 16 specifically depicts certain elements of the diaphragm assembly, including the magnet 1057 and the diaphragm 1055. The lower body 1011b and the lower valve assembly body 1200b together form the diaphragm chamber as described elsewhere herein. FIG. 16 further illustrates lower body 1011b supporting the control board 1070 via the control board mount 1070m and control board wires 1071a, 1071b extending from the control board 1070, providing electrical connectivity to the electromagnetic features of the diaphragm assembly. Also present on the control board 1070 are a sensor 1080, such as a pressure sensor, which has the sensor gasket 1085 forming a seal between the sensor 1080 and the upper body 1011a, and the blow-off valve 1060. The blow-off valve diaphragm 1065 is illustrated in FIG. 16, while the upper sections of the blow-off valve, including its exit port, are not specifically pictured.

Still referring to FIG. 16, lower valve assembly body 1200b is attached to the upper surface of the outer ring of diaphragm 1055 in the manner described herein (see, for example, FIGS. 12A, 12B, 13A, and 13B and the related description). The lower valve assembly body 1200b can include the valve recesses, inlet ports, and sealing surfaces necessary to provide the valve action described herein. These features can be integrally formed into the lower valve assembly body 1200b, such as by injection molding a unitary part, they can be formed from multiple molding process, or they can be fabricated into the lower valve assembly body 1200b by cutting or machining or the like. The lower valve assembly gasket 1205b is placed between lower valve assembly body 1200b and upper valve assembly body 1200a and provides a fluid tight seal to the valve chambers. The inlet valve 1020a and outlet valve 1020b can float within the valve chambers and function as described elsewhere herein.

Again still referring to FIG. 16, upper valve assembly body 1200a is similar to lower valve assembly body 1200b in that it can include the valve recesses, inlet ports, and sealing surfaces necessary to provide the valve action described herein and such features can be formed in the same variety of ways described for lower valve assembly body 1200b. Further, the fluid flow paths necessary to provide connections among the valve chambers, pressure sensor, and blow-off valve can be formed in upper valve assembly body 1200a. The upper valve assembly gasket 1205a can form the upper boundary of some of these flow paths and provides a seal between the upper valve assembly body 1200a and the upper body 1011a. The upper body 1011a, in turn, can also have flow paths, which in FIG. 16 are depicted as upper body channels 1008. The upper valve assembly gasket 1205a and the upper body seal 1009 for the lower and upper boundaries, respectively, for certain flow paths. Further, the cutouts in the upper valve assembly gasket 1205a provide a fluid connection to the inlet port 1012 and outlet port 1014 on the upper body 1011a. Screws 1001 are used in the final assembly of the miniature pump 1010, but of course other methods of securing the upper body 1011a to the lower body 1011b can be used.

The flow paths in the upper body 1011a provide several connections, such as: (1) a connection between the blow-off valve and the inlet port of the miniature pump; (2) a connection between the blow-off valve and the outlet port of the miniature pump; and (3) a connection between the pressure sensor and the suction chamber.

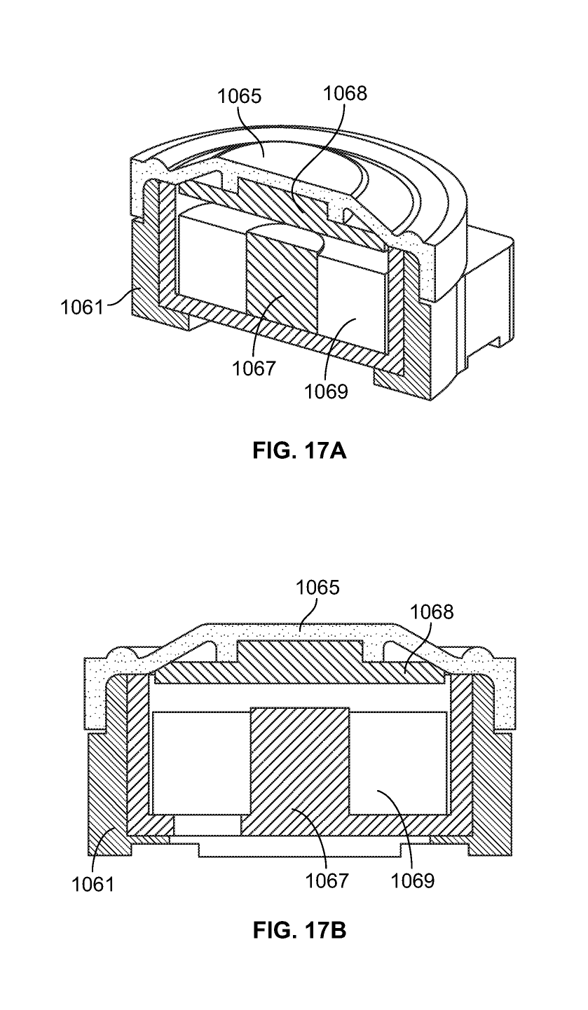

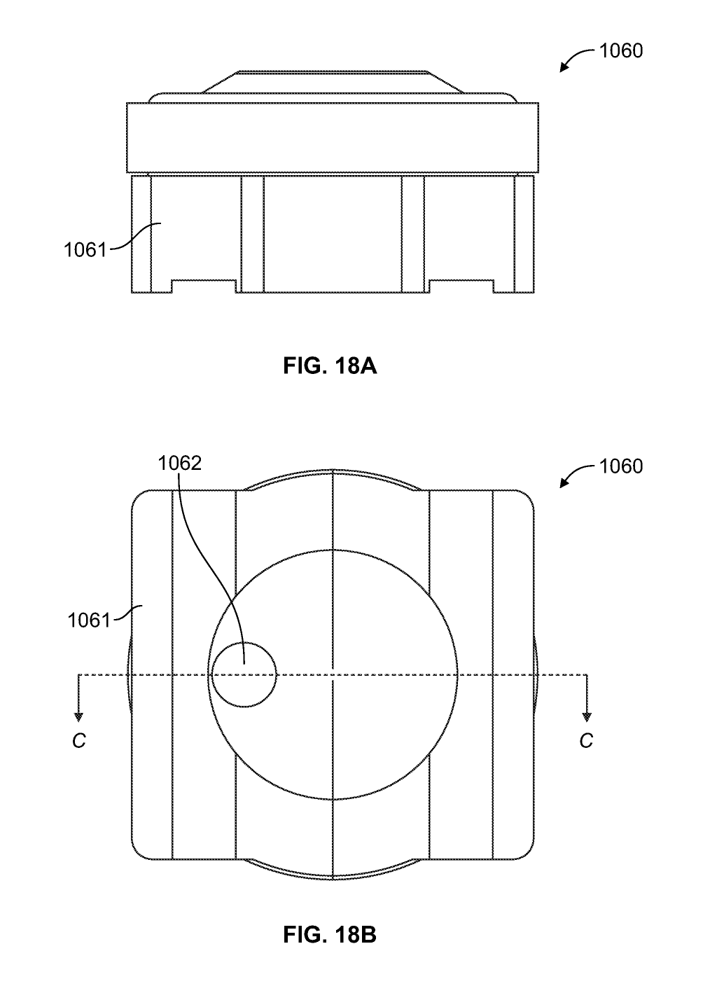

FIGS. 17A and 17B illustrate different views of a cross-section of a portion of one embodiment of a blow-off valve. The upper surface of the blow-off valve diaphragm 1065 engages a port on the outer case of the blow-off valve (which is not pictured). The underside of the blow-off valve diaphragm 1065 is secured to a blow-off valve attractor plate 1068, which is formed from a ferrous material. Below the blow-off valve attractor plate 1068 is the blow-off valve yoke 1067 and the blow-off valve coil 1069, which cooperate to provide electromagnetic forces that can attract the blow-off valve attractor plate 1068. The blow-off valve diaphragm 1065 is formed such that in its resting state it forms a seal against the port on the blow-off valve. When current is run through the blow-off valve coil 1069, the blow-off valve attractor plate 1068 is pulled down, which in turn pulls the blow-off valve diaphragm 1065 away from its sealed position. The blow-off valve yoke 1067, blow-off valve coil 1069, and blow-off valve attractor plate 1068 are housed within the blow-off valve case 1061. FIGS. 18A and 18B illustrate exterior views of the blow-off valve 1060, including the blow-off valve port 1062 and blow-off valve case 1061.

The blow-off valve diaphragm 1065 can be formed from materials such as silicone rubber or its equivalents. The blow-off valve attractor plate 1068 and the blow-off valve yoke 1067 can be formed from alloys with comparatively high magnetic permeability, such as a nickel-iron alloy. The blow-off valve coil 1069 can be formed from winding copper or other conductive wire. The blow-off valve case 1061 can be formed from a polymer-based material, such as a glass-filled polycarbonate.

The blow-off valve functions by having a minimum preload that presses the diaphragm against the valve port to ensure that the valve is closed prior to initiating suction.

The preload can be chosen by using a diaphragm material with sufficient elastic modulus such that the diaphragm remains engaged against valve port in the assembled state. In some embodiments, the blow-off valve can further include a non-magnetic compression spring within the electromagnet assembly that always pushes up on the attractor plate. In this scenario, the diaphragm would be designed to be as flexible as possible and preload could vary in accordance with the tolerances associated with the spring constant and the free length.

Because this electromagnetic blow-off valve operates within a miniature pump that itself is driven by electromagnetic forces, it is necessary to take into account the overall magnetic fields experience by the attractor plate. The valve diaphragm should be stiff enough to not be affected by such peripheral magnetic forces. That is, the diaphragm should resist unwanted displacement via interaction between the attractor plate coupled to the diaphragm and the peripheral magnetic fields. Yet, a stiffer diaphragm requires a stronger local magnetic field to displace it and the attractor plate. One method to achieve a desirable local magnetic field is to optimize the number of coil turns in the blow-off valve coil. A greater number of coil turns can be achieved by growing the overall electromagnet in height or diameter. While it is more space efficient to grow in height (resistance increases more slowly given lower total wire length which can prevent having to jump to a lower gauge wire), increases in the outer diameter can also provide space for more coils, which may utilize the available enclosure space more effectively.

In some embodiments, the maximum current available to the electromagnet is assumed to be 300 mA. This is based on limitations of the battery (1C max). If higher currents could be sourced, the resistance of the component (current 10-12 ohms) would also have to be reduced given the assumed minimum battery voltage of 3.0 V for a miniature pump. In general, the current draw of the blow-off valve should be monitored according to the application of the miniature pump.

Reference to a “blow-off valve” herein refers generally to any suitable valve used to control or limit the pressure in a system or vessel. Such valves may be known by a variety of names, including relief valves, release valves, safety valves, and the like. The embodiments of the invention herein encompass all such valves regardless of the name of the valve utilized herein.

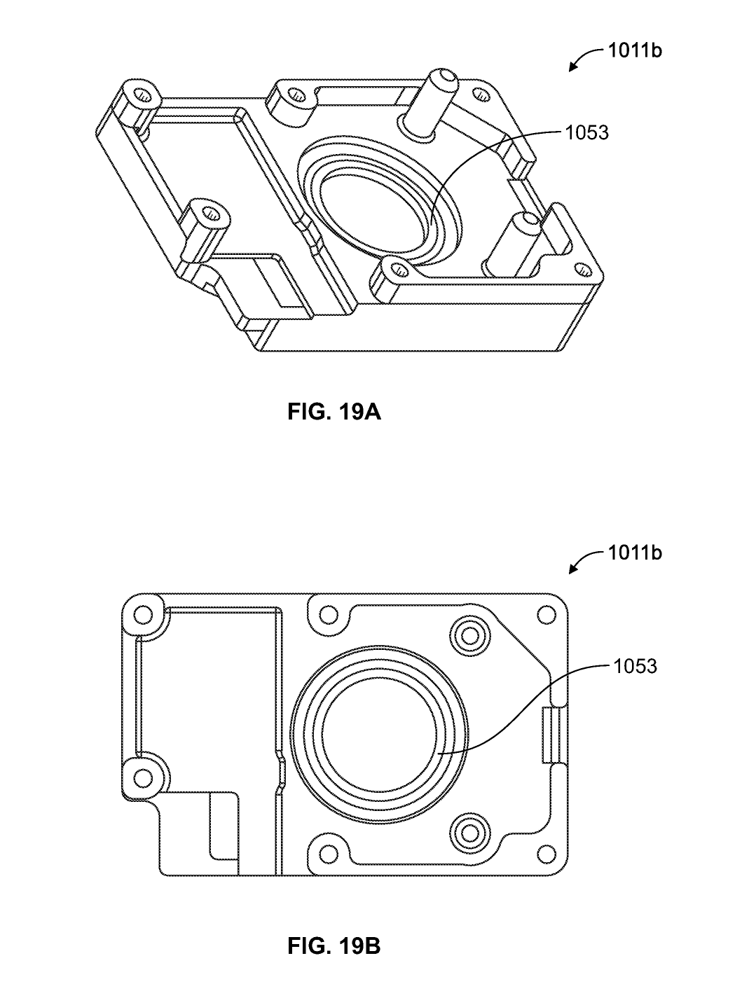

FIGS. 19A and 19B illustrate different views of a lower pump body 1011b according to certain embodiments. The lower pump body 1011b includes a cutout that forms a diaphragm spacer 1053. The edge of the diaphragm contacts the edge of the diaphragm spacer 1053 and is thereby spaced away from the actuator membrane of the actuator that is attached to the underside of the lower pump body 1011b.

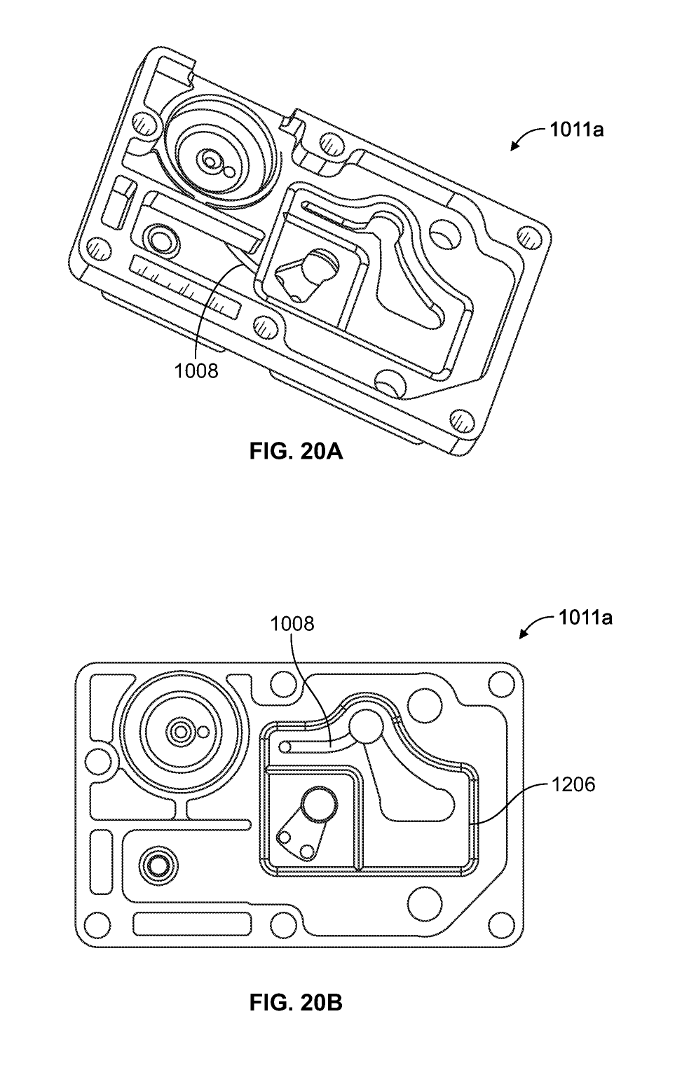

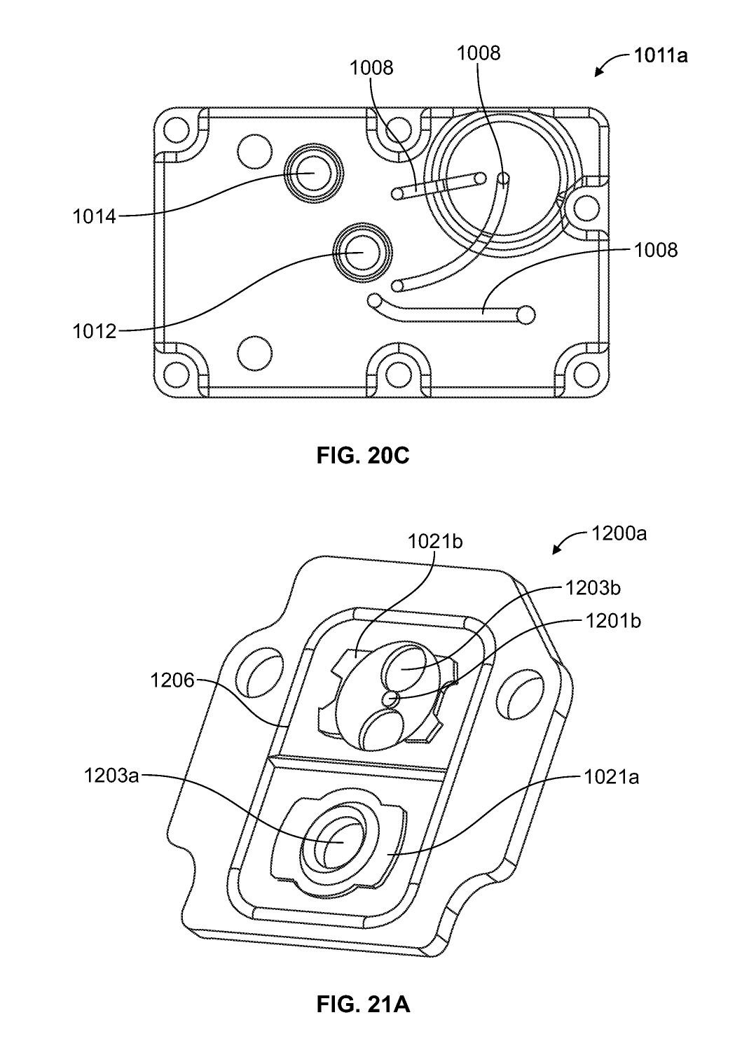

FIGS. 20A, 20B, and 20C illustrate different views of an upper pump body 1011a according to certain embodiments. The upper pump body 1011a includes upper body channels 1008, which connect the ports 1012 and 1014 to the sensor area and the blow-off valve area of the upper pump body 1011a. The upper pump body 1011a includes a sealing feature 1206. A sealing feature 1206 generally circumscribes the areas of the upper pump body 1011a the areas of the upper pump body 1011a in which fluid is handled. The sealing feature 1206 can be a raised area, such as a ridge, that mechanically interacts with a gasket to form a reliable seal around the fluid handling area.

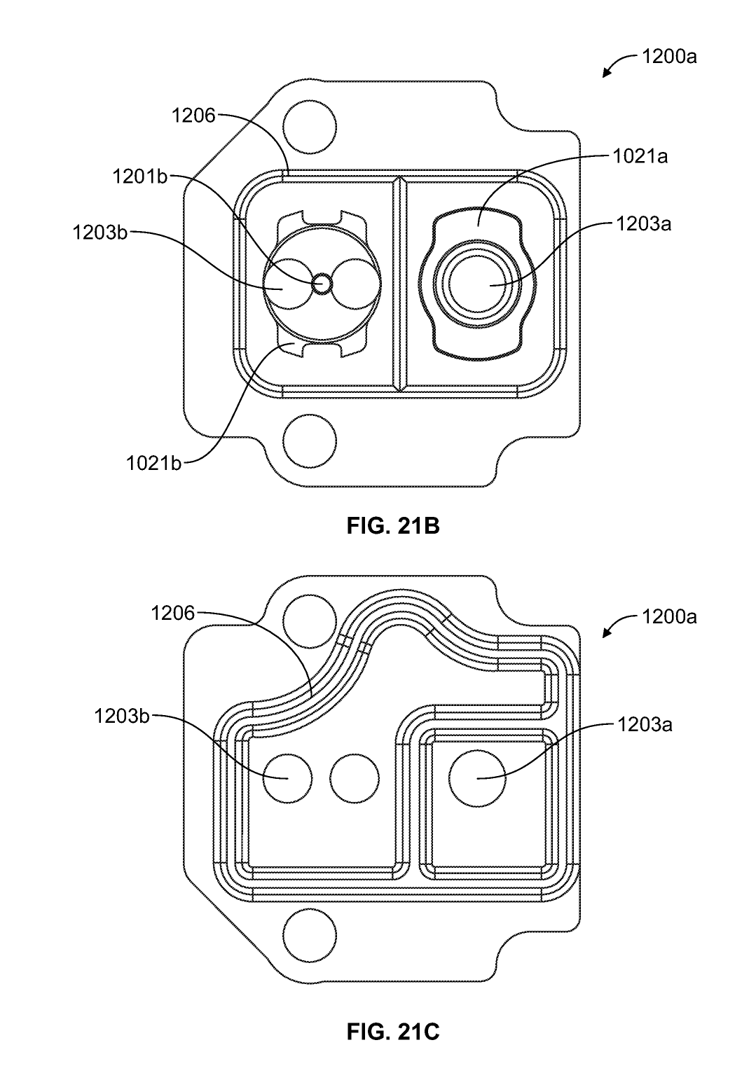

FIGS. 21A, 21B, and 21C illustrate different views of an upper valve assembly body 1200a according to certain embodiments. The upper valve assembly body 1200a includes ports, recesses and offsets similar to those described elsewhere herein. FIG. 21A depicts a semi-transparent perspective view of the lower surface of the upper valve assembly body 1200a and FIG. 21B depicts a plan view of that same surface. The upper valve assembly body 1200a includes inlet valve recess 1021a and outlet valve recess 1021b, which provide a seating area for the inlet valve and outlet valve, respectively. The inlet and outlet valves interact with the upper inlet chamber port 1203a and upper outlet chamber port 1203b to provide the valved pumping action described herein. Further, the upper valve assembly body 1200a includes outlet port offset 1201b. A sealing feature 1206 is present on this lower surface of the upper valve assembly body 1200a to provide improved sealing to the lower valve assembly gasket 1205b and separation of the inlet and outlet areas. FIG. 21C depicts the upper surface of the upper valve assembly body 1200a, having the upper inlet chamber port 1203a and upper outlet chamber port 1203b. A sealing feature 1206 is present on this upper surface of the upper valve assembly body 1200a to provide improved sealing to the upper valve assembly gasket 1205a and separation of the inlet and outlet areas.

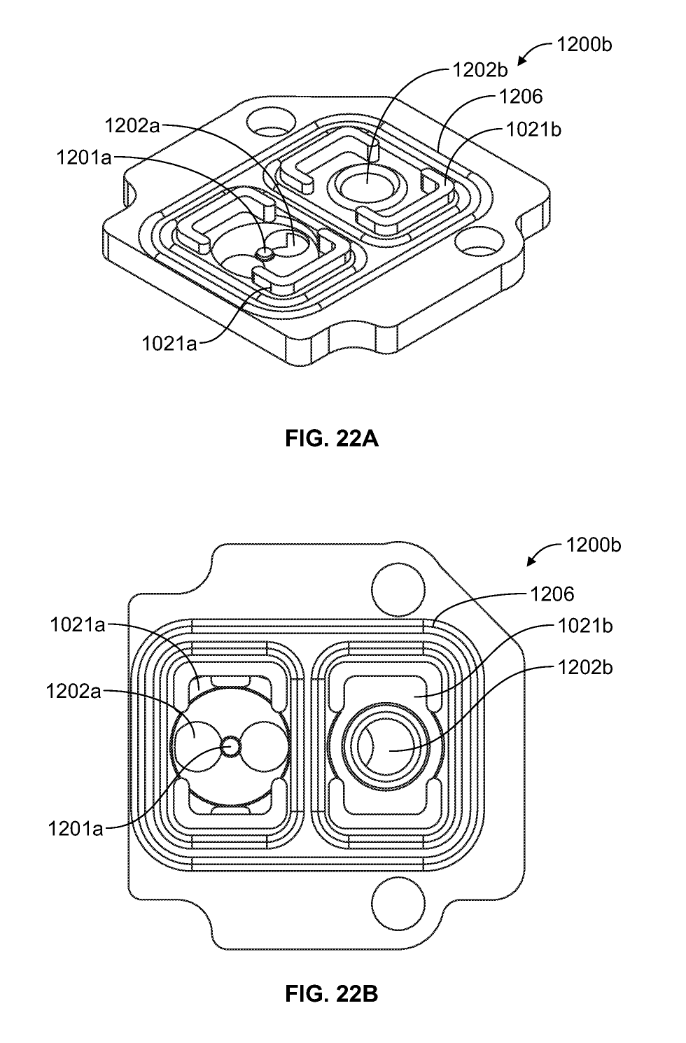

FIGS. 22A and 22B illustrate different views of a lower valve assembly body 1200b according to certain embodiments. FIG. 22A depicts a semi-transparent perspective view of the upper surface of the lower valve assembly body 1200b and FIG. 22B depicts a plan view of that same surface. The lower valve assembly body 1200b includes inlet valve recess 1021a and outlet valve recess 1021b, which provide a seating area for the inlet valve and outlet valve, respectively. The inlet and outlet valves interact with the lower inlet chamber port 1202a and lower outlet chamber port 1202b to provide the valved pumping action described herein. Further, the upper valve assembly body 1200a includes inlet port offset 1201a. A sealing feature 1206 is present on this upper surface of the lower valve assembly body 1200b to provide improved sealing to the lower valve assembly gasket 1205b and separation of the inlet and outlet areas.

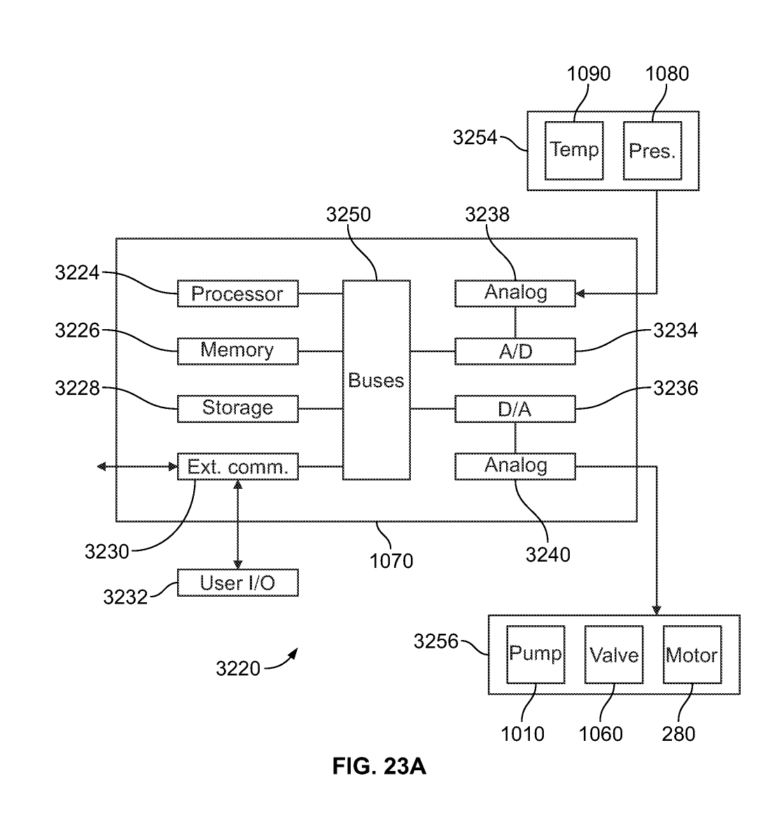

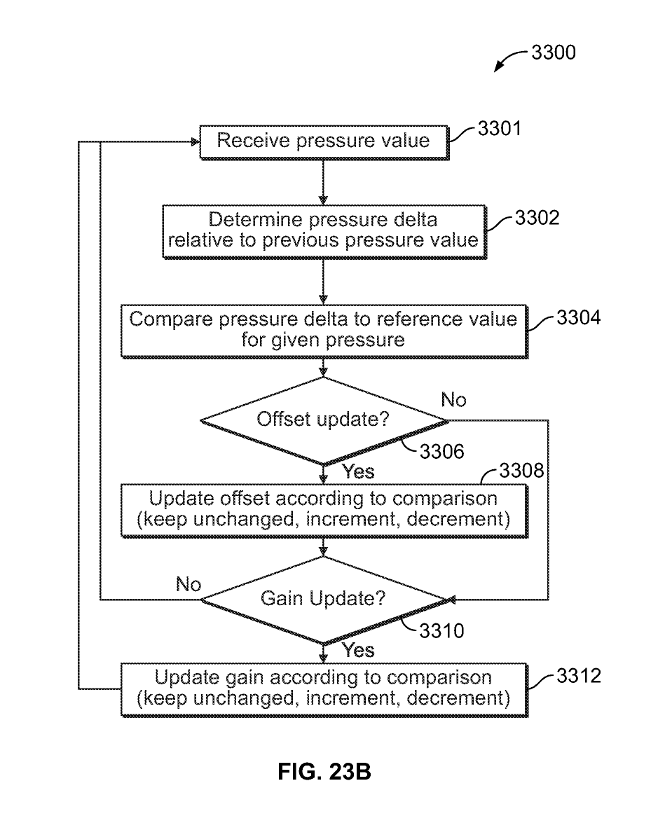

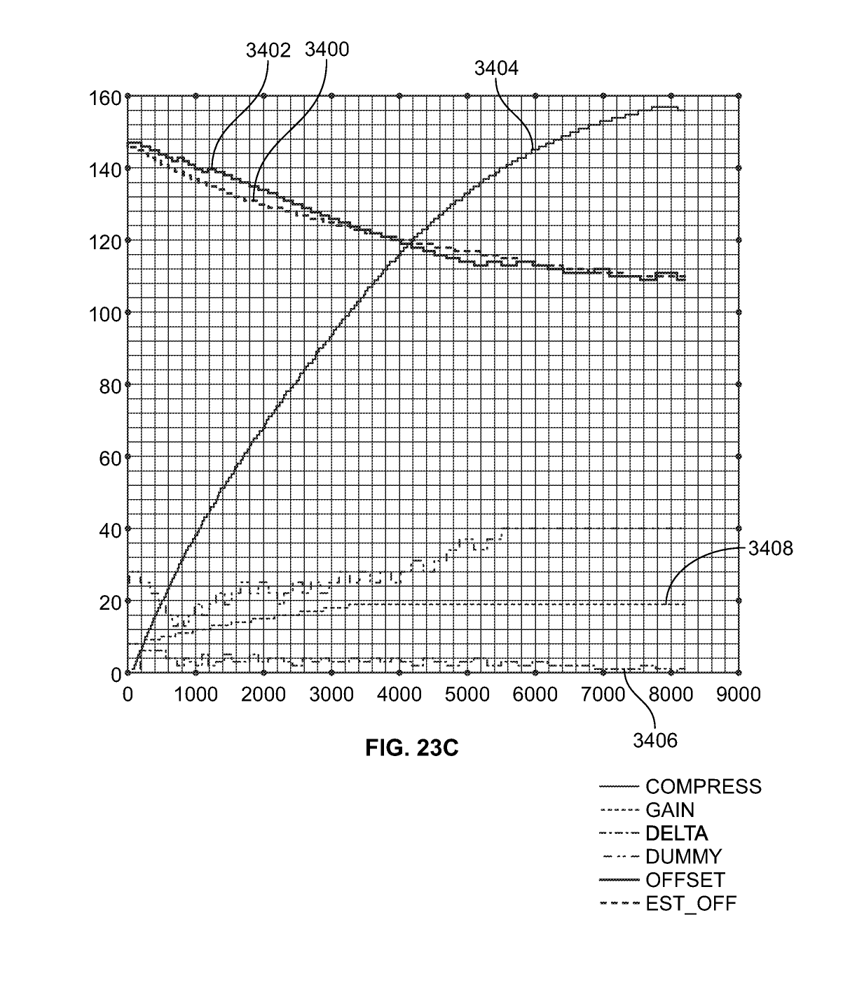

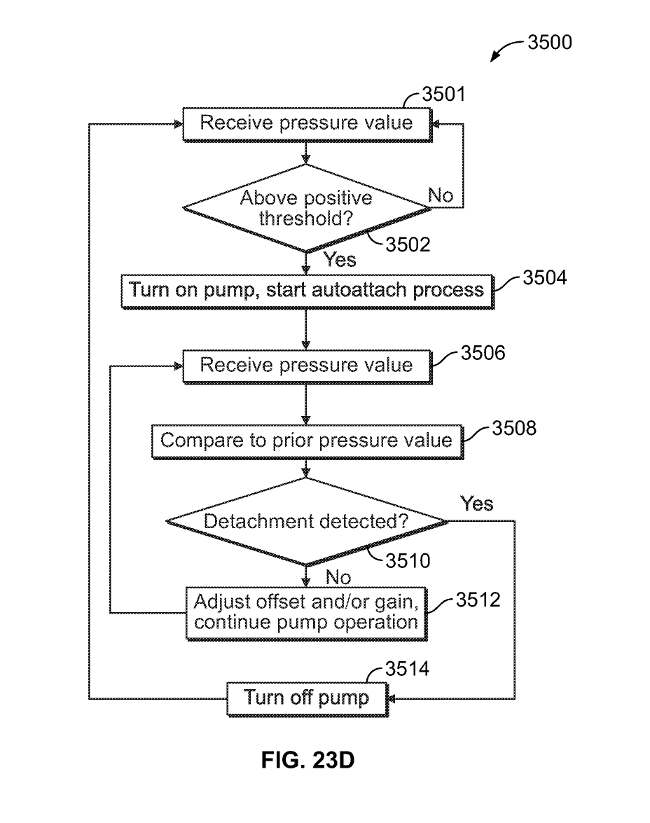

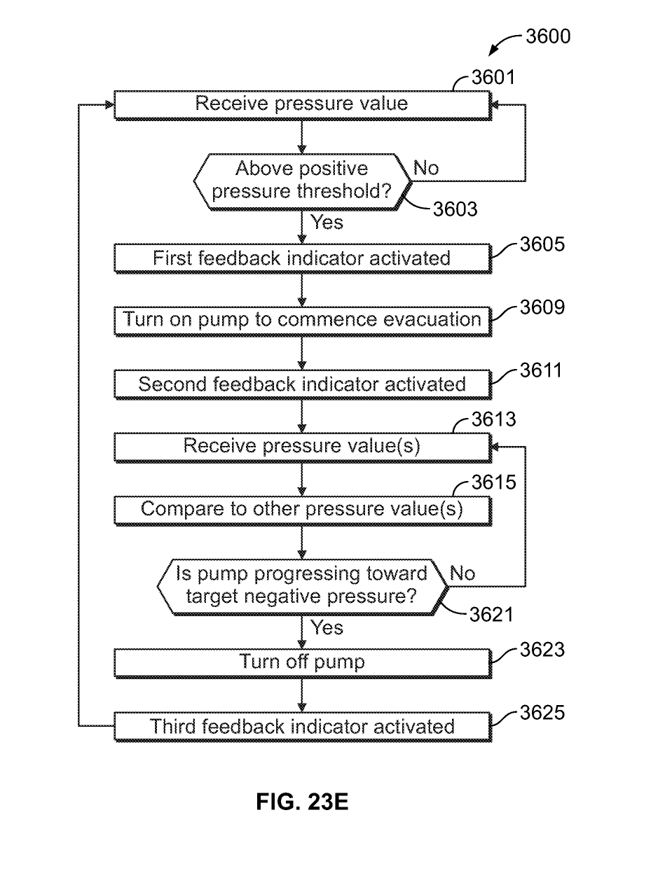

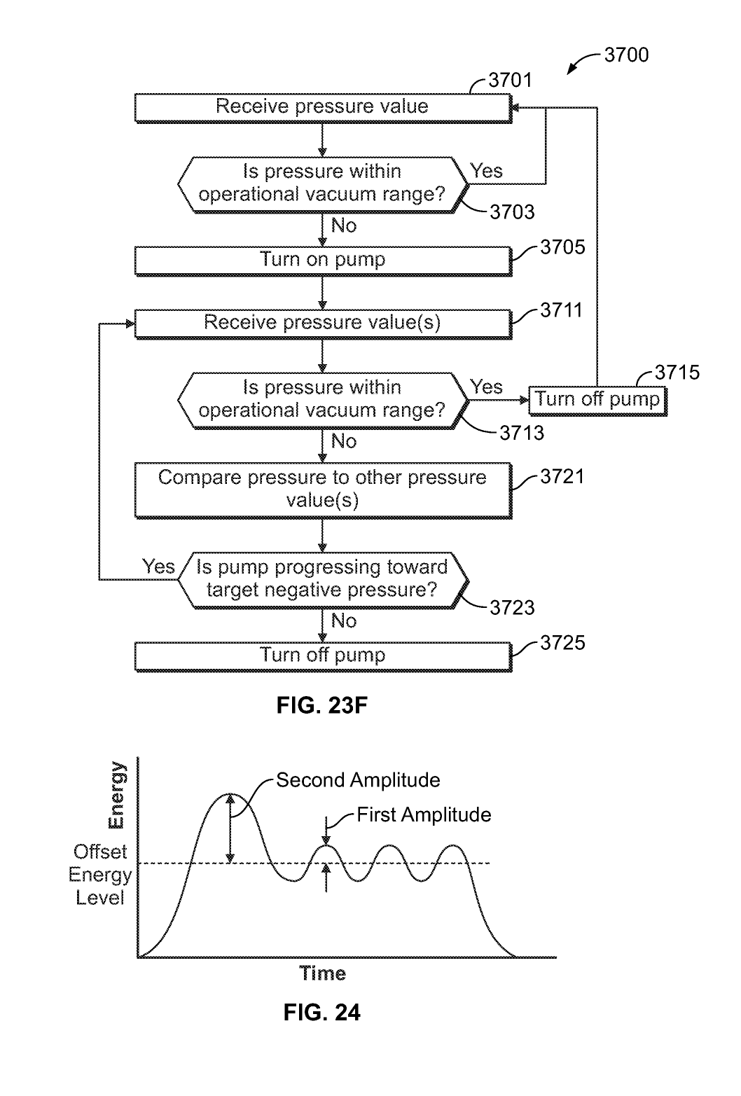

FIG. 23A illustrates a control and I/O subsystem 3220 including a number of control, storage, and I/O components according to some embodiments of the present invention. In one embodiment, subsystem 3220 is part of controller block 215, controller block 3215 or both. Some of the components may be part of the control board 1070, while others, such as a set of user input-output (I/O) devices 3232, sensors 3254 and active mechanical devices 3256 may be electrically connected to, but physically separated from, the control board 1070. Sensors 3254 can include one or more pressure sensors 1080 and one or more temperature sensors 1090, which provide real-time indicators of pressure and temperature within the device suction chamber. Temperature sensors 1090 can include one or more temperature sensors 5241, one or more temperature sensors 5242 or any combination of the foregoing. Other sensors may include flow sensors, accelerometers, and others. Active mechanical devices 3256 include one or more suction pumps 1010, one or more blow-off or other valves 1060, and one or more stimulators or motors 280.

In some embodiments, the control board 1070 includes a processor 3224, a memory 3226, a set of storage devices 3234, and a set of external communications interface controller(s) 3230, and analog-to-digital (A/D) converter 3234, and a digital-to-analog (D/A) converter 3236, all interconnected by a set of buses 3250. Analog circuitry 3238 is connected to A/D converter 3234. Analog circuitry 3238 includes components such as amplifiers and filters configured to perform analog processing such as amplification and filtering on analog signals received by the control board 1070 from external sensors. Analog circuitry 3240 is connected to D/A converter 3236. Analog circuitry 3240 includes components such as amplifiers configured to perform analog processing such as amplification on analog signals received from D/A converter 3236. A/D converter 3234 and D/A converter 3236 connect the processor 3224 to the blow-off valve, sensor, and diaphragm, as described below. In some embodiments, at least some of the illustrated sensors (e.g. pressure sensor(s) 1080) may be digital sensors connected to processor 3224 through a digital bus such as an I2C bus.

In some embodiments, the processor 3224 comprises one or more microcontroller integrated circuit(s) or other microprocessor(s) configured to execute computational and/or logical operations with a set of signals and/or data. Such logical operations can be specified for the processor 3224 in the form of a sequence of processor instructions, such as machine code or other type of software. Such instructions can be controlled by firmware or stored in memory or storage 3228 and then executed by the processor. Any or all of the numbers, values and ranges utilized by processor 3224 during the operation of device 200 can be calculated during the operation of the device 200, predetermined or predefined, stored in storage 3228 or any combination of the foregoing. Any or all of the pressures and temperatures sensed or measured during the operation of device 200 can be stored in storage 3228 for use by processor 3224. In some embodiments, processor 3224 may include multiple discrete microprocessors interconnected by a connection such as a serial bus or a single microprocessor. For example, processor 3224 may include a Bluetooth microprocessor connected to a control system-on-chip (SoC) through a Universal Serial Bus (USB), RS232, UART or other digital connection. A memory unit 3226 may comprise random access memory, for example random access memory (RAM) or dynamic random access memory (DRAM), for storing data/signals read and/or generated by processor 3224 in the course of carrying out instructions. The processor 3224 may also include additional on-die RAM and/or other storage.

Storage devices 3228 include computer-readable media enabling the non-volatile storage, reading, and writing of software instructions and/or data, and can be EEPROM/flash memory devices or any other suitable memory device(s). Communications interface controller(s) 3230 allow the subsystem 3220 to connect to digital devices/computer systems outside the control board 1070 through wired and/or wireless connections. For example, wired connections may be used for connections to components such as user I/O devices 3232, while wireless connections such as Wi-Fi or Bluetooth connections may be used to connect to external components such as a smartphone, tablet, PC or other external controller. Buses 3250 represent the plurality of system, peripheral, and/or other buses, and/or all other circuitry enabling communication between the processor 3224 and devices 3226, 3228, 3230, 3234, and 3236. Depending on hardware manufacturer, some or all of these components may be incorporated into a single integrated circuit, and/or may be integrated with the processor 3224.

User I/O devices 3232 include user input devices providing one or more user interfaces allowing a user to introduce data and/or instructions to control the operation of subsystem 3220, and user output devices providing sensory (e.g. visual, auditory, and/or haptic) output to a user. User input devices may include buttons, touch-screen interfaces, and microphones, among others, provided on the device housing or on a smart phone or remote control. User output devices may include one or more display devices, speakers, and vibration devices, among others, provided on the device housing or on a smart phone or remote control. Input and output devices may share a common piece of hardware, as in the case of touch-screen devices. In some embodiments, user I/O devices 3232 incorporated with the device housing include a status LED light and three user control buttons: a mode button, which can be used to switch between adjusting suction levels and mechanical stimulation levels and/or manual and autoattach modes described below, and level increase (+) and decrease (−) buttons, which can be used to adjust pump and/or motor settings. A remote control may include similar user control buttons and status light.

In some embodiments, the processor 3224 controls the positioning of the pump diaphragm by using analog circuitry 3240 to dynamically control a DC offset and a gain of a diaphragm drive signal. The offset level controls the DC bias of the pump diaphragm, while the gain controls the amplitude of a sinusoidal or other periodic signal waveform; the periodic signal amplitude and offset determine the amplitude of the excursion of the pump diaphragm from its resting position. The offset and gain may be controlled dynamically in response to measured operational parameters in order to achieve desired operational characteristics, as described below. In particular, the offset and/or gain may be changed in response to variations in pressure measured using a sensor. In some embodiments the minimum and maximum applied force, which control the excursion of the pump diaphragm, may be controlled using other two discrete parameters such as a minimum and a maximum signal amplitude.

As the pump operates over time in a given evacuation sequence, the pressure differential across the pump diaphragm generally increases. Without changes in offset and gain, the increasing pressure differential would lead to a gradual change in the resting position of the pump diaphragm. The increase in pressure difference leads to changes in the optimal offset and gain values for achieving particular pump characteristics such as maximum rate of increase in pressure difference (pumping speed), minimum current consumption (or maximum energy efficiency), or minimal noise. In some embodiments, the offset is decreased (or increased) over time to compensate for the effect of the increased pressure differential across pump diaphragm on the resting position of the diaphragm. The offset and gain values may be varied according to a pressure lookup table, and/or according to dynamically measured changes in one or more parameters of interest, such as a pressure difference (delta) observed over one pump cycle.

FIG. 23B shows a flowchart illustrating a number of steps of a process 3300 to dynamically control the input energy waveform to the diaphragm, for example to voice coil actuator 15 to control diaphragms 55 or 1055, according to pressure values measured by the sensor within the pump, for example sensor 80, according to some embodiments of the present invention. The controller of the sexual arousal device of the invention, for example control block 215, processor 3224 or both, can be configured to perform process 3300, or any part thereof. As indicated above, the pressure measured in the pump can approximate the pressure in suction chamber 220. In one embodiment, a direct current (DC) value, which can be referred to as an offset value, is applied to the voice coil actuator 15 to set the midpoint of an energy oscillation waveform, which can be in the form of a sine wave, to be applied to the actuator 15. The amplitude of the waveform relative to the offset value can be referred to as the gain of the actuator 15. In a step 3301, processor 3224 receives an instantaneous pressure value measured by the pressure sensor 1080, which can be sensor 80, for the current pump cycle. In a step 3302, the pressure difference or delta relative to a previously-measured pressure value, for example a pressure value measured for the immediately-prior pump cycle, is determined. In a step 3304, the determined pressure delta is compared to one or more reference values in order to determine a magnitude and/or sign of offset and/or gain adjustments to the input energy waveform to the pump to be made for subsequent pump cycles. A reference value may be equal to or otherwise determined according to a pressure delta measured for an immediately-previous pump cycle, or an expected pressure delta for a given measured pump pressure as retrieved from a calibration table in storage 3228 or otherwise from storage 3228. Performing such a comparison in step 3304 may comprise subtracting a reference value from the measured pressure delta to arrive at an offset and/or gain adjustment value.

In a step 3306, it is determined whether the offset is to be updated for the next pump cycle based on the offset adjustment value from step 3304 or otherwise. In some embodiments, the determination whether to update the offset may be performed independently of the pressure delta comparison described above. For example, offset updates may be performed during certain blocks of cycles while gain updates are performed during other blocks of cycles, in order to attempt to separate the measured effects on pressure delta of offset and gain changes. In another example, offset and gain updates may be performed on alternating pump cycles. In some embodiments, both offset and gain updates may be performed during at least some pump cycles. In some embodiments, a determination whether to update the offset may be performed according to the pressure delta comparison described above, if it is determined that an offset change is likely to improve pump performance.

In a step 3308, the offset is updated according to the pressure delta comparison performed in step 3304, for example as a function of the offset adjustment value from step 3304. In some embodiments, updating the offset comprises incrementing or decrementing the offset by a fixed step (e.g. ±1) if it is determined that such incrementing/decrementing is likely to lead to improve pump performance on the next pump cycle.

In a step 3310, is it determined whether the gain is to be updated for the next pump cycle based on the gain adjustment value from step 3304 or otherwise. Step 3310 may be performed in a manner similar to that described above for step 3306. Subsequently, in a step 3312, the gain is updated according to the pressure delta comparison performed in step 3304, for example as a function of the gain adjustment value from step 3304. In some embodiments, updating the gain comprises incrementing or decrementing the gain by a fixed step (e.g. ±1) if it is determined that such incrementing/decrementing is likely to lead to improve pump performance on the next pump cycle.

FIG. 23C illustrates an exemplary evolution over a number of pump cycles of several parameters described above, according to some embodiments of the present invention. The x-axis denotes time (or pump cycles), while the y-axis illustrates the various parameter values. An estimated offset 3400 represents an offset chosen according to a predetermined calibration table, independently of dynamically-measured pressure values. A dynamically-determined offset 3402 represents an offset chosen according to dynamically-determined pressure delta values as described above in process 3300. A vacuum level (compression) 3404 represents the measured vacuum level in the pump, or pressure differential across the diaphragm, for example diaphragms 55 or 1055. A gain 3408 represents a gain of the pump drive signal. A pressure delta 3406 represents the pressured delta observed over each pump cycle, i.e. effectively the derivative of the vacuum level 3404.

As illustrated in FIG. 23C, the vacuum level 3404 increases over time as the pump operates, with the per-cycle pressure delta 3406 generally decreasing over time as the pump works against an increasing diaphragm pressure differential. The gain 3408 suitable for maintaining the pump in an optimal operating regime increases over time. At each time point, a low gain leads to a suboptimal displaced volume, while a high gain can lead to a loss of efficiency and/or noise if the diaphragm, for example diaphragms 55 or 1055, collides with its housing or internal structure in the pump at the end of its excursion. At the same time, the offset corresponding to an optimal operating regime decreases over time, compensating for the effect of the pressure differential across the diaphragm, for example on the central position of diaphragms 55 or 1055. The dynamically-determined offset 3402 may differ from the previously-determined (calibrated) offset 3400, for example due to differences between the individual characteristics of the pump (which determine the offset 3402) and the general pump characteristics used to generate the calibration data determining the estimated offset 3400. For example, while the general offset 3400 decreases monotonically, the dynamically-determined offset 3402 occasionally increased. Also, the dynamically-determined offset 3402 at times decreased at a different rate than the general offset 3400. Using dynamically-determined offset 3402 facilitates the manufacture of pumps using less-stringent manufacturing tolerances, as optimal pump operation is less dependent on any mismatch between individual pump characteristics and the general pump characteristics reflected in calibration data.

In some embodiments, a pump and associated control system as described above may be used to generate pressure patterns other than a monotonically-increasing one such as the one illustrated in FIG. 23C. For example, alternating pressure (suction) periods may be used by alternating periods of increased pumping (and/or decreased associated relief valve use) with periods of decreased or stopped pumping (and/or increased associated relief valve use).

Control system of device 200 can be utilized to implement an auto-attach mode of suction chamber 220 of the device to the tissue surrounding the user's clitoris. The auto-attach mode may be provided as a user-selected alternative to a manual operating mode. In the manual operating mode, the pump is started immediately in response to user input such as pressing a pump-start button. In contrast, in an auto-attach mode the pump is automatically started in response to the detection of positive pressure indicative of the establishment of contact of the sealing flange 225 (FIGS. 1A-1D) to a user's tissue, for example the tissue surrounding the user's clitoris.

FIG. 23D shows an exemplary sequence of steps of one embodiment of an auto-attach mode process 3500, which can be used separately or in combination with any of the other processes herein or otherwise. For example, some or all of process 3500 can be used in combination with process 3300. The controller of the sexual arousal device of the invention, for example control block 215, processor 3224 or both, can be configured to perform process 3500, or any part thereof. In a step 3501, the controller receives a current measured pressure value within the pump while the pump is off. Such measured pressure value can approximate the pressure in suction chamber 220. In a step 3502, such controller or processor 3224 compares the measured pressure value to a predetermined positive threshold pressure value. Detecting a high level of positive pressure within the suction chamber 220, for example a pressure above atmospheric pressure, indicates that the chamber 220 has been engaged with the user's tissue and at least somewhat sealed against the user's tissue. Such positive pressure within suction chamber 220 is caused by a reduction of the fluid volume within the chamber as the user's clitoris and adjoining tissue is urged into the chamber while flange 225 has achieved a level of sealing with the tissue surrounding the clitoris. If the measured pressure is not above the positive threshold pressure value, the process returns to step 3501. If the measured pressure is above the threshold, processor 3224 starts the pump auto-attach process by turning on the pump, in step 3504. Activation of the pump commences evacuation of the suction chamber 220 and the creation of a negative pressure or vacuum within the suction chamber. A current pressure value for the present pump cycle is received in a step 3506, for example a negative pressure within the pump, and compared to a prior pressure value in a step 3508. In a step 3510, it is determined whether the measured pressure value(s) indicate that the chamber seal has been breached. For example, a sudden large drop in pressure or a return to atmospheric or nominal pressure may indicate that the suction chamber is no longer sealed to the user's tissue. If no major loss of seal is detected, the commanded pressure is adjusted, and the dynamically tuned parameters offset and/or gain are adjusted in step 3512, for example as described above in steps 3308 and 3312 with respect to the method of FIG. 23B, and the process returns to step 3506 to receive a pressure value for the next pump cycle. If major loss of seal is detected, the pump is turned off, in step 3514, and the process returns to step 3501 to allow detecting a new engagement of a chamber.

In some embodiments, step 3512 may include turning on and off the pump so as to maintain a certain level of negative pressure. Step 3512 may include monitoring parameters such as the fraction of time that the pump is on or the pump pressure is low to determine whether to increase or decrease the pump's activity. The pump then self-regulates to maintain a certain level of negative pressure.

In one embodiment of the invention, activation of the pump 1010 commences evacuation of the suction chamber, and thus creation of negative pressure in the chamber and in the vicinity of the clitoris. In one embodiment, pump continues evacuating suction chamber 220 until a target negative pressure is achieved, at which point the sexual arousal device is deemed attached to the user. In one embodiment, the target negative pressure or vacuum pressure is sufficient to retain suction chamber 220 secured or attached to the tissue of the user surrounding the clitoris during stimulation of the clitoris by the device 200, for example stimulation of the clitoris by the negative pressure, by the one or more active stimulators 280 disposed in chamber 220 or both. In one embodiment, the active stimulators are vibratory motors 280. The target negative pressure can be measured relative to atmospheric or ambient pressure. In one embodiment, the target negative pressure can range from about negative 2.5 to about negative 8.0 inches of mercury (inHg). In one embodiment, the target negative pressure can range from about negative 4.75 to about negative 6.5 inches of mercury. In one embodiment, the target negative pressure is at least approximately negative three inches of mercury. In one embodiment, the target negative pressure is approximately negative 5.75 inches of mercury. The duration of time for the sexual arousal device to typically reach such target negative pressure can be of any suitable length and in one embodiment is between about five to ten seconds.

An exemplary sequence of steps of one embodiment of a process 3600 to achieve a target negative pressure in suction chamber 220 of the sexual arousal device of the invention is illustrated in FIG. 23E. The controller of the device of the invention, for example control block 215, processor 3224 or both, can be configured to perform process 3600, or any part thereof. Process 3600 can be used separately or in combination with any of the other processes herein or otherwise. For example, some or all of process 3600 can be used in combination with process 3300, process 3500 or both. In this regard, the process may be utilized with a manual operating mode or an auto-attach mode. Process 3600 advantageously provides feedback to the user during evacuation of the female sexual arousal device of the invention. Such feedback can aid the user in proper placement of the device, can indicate to the user the status of the device during suction chamber 220 evacuation, can mitigate against overheating of the pump 1010, can enhance battery life of the sexual arousal device of the invention or achieve any combination of the foregoing.

In response to the user placing the sealing flange 225 of the sexual arousal device of the invention against the tissue surrounding the user's clitoris in one application of process 3600, the controller of sexual arousal device, for example control block 215 or processor 3224, receives a current measured pressure value within suction chamber 220, for example from pressure sensor 1080 in the chamber 220, in a step 3601 while the pump 1010 is off. In a step 3603, such controller or processor 3224 compares the measured pressure value to a predetermined or previously-calculated positive threshold pressure value, for example stored in storage 3228. Detecting a high level of positive pressure within the suction chamber 220, for example a pressure above atmospheric or nominal pressure, indicates that the chamber 220 has been engaged with the user's tissue and at least somewhat sealed against the user's tissue. If the measured pressure is not above the positive threshold pressure value, the process returns to step 3601.

If the measured pressure is above the threshold, processor 3224 can activate a first feedback indicator, as indicated in a step 3605. The first feedback indicator can be of any suitable type and can include a visual indicator, an audio indicator, a tactile indicator, a cessation or change in status or state of any such indicators, or any combination of the foregoing. In one embodiment, the first indicator includes a first visual feedback indicator such as a first activation sequence of one or all of first indicators or LEDs 283. One such activation sequence is a turning on or single pulse of at least one of LEDs 283. In one embodiment, the activation sequence is a single green pulse of one or more LEDs 283. Such visual indicators can be helpful in a variety of situations, for example when the surroundings are dark or when the user can see sexual arousal device, for example device 200. In one embodiment, the first feedback indicator includes a first audible feedback indicator such as an audible signal or noise generated by the device that can be heard by the user. In one embodiment, the first feedback indicator includes a first tactile feedback indicator such as a vibration or other sensation generated by the device 200, such as for example a first pulsing sequence of vibratory motors 280 that can be felt by the user. One such first pulsing sequence is a single pulse of at least one of vibratory motors 280. In one embodiment, the single pulse of at least one of the LEDs 283 and of at least one of vibratory motors 280 occurs simultaneously. First feedback indicators can serve to alert the user of a good seal between device 200 and the user's tissue and, for example, advise the user that further adjustment of the device is not needed at this time. Similarly, the absence of such first feedback indicators can alert the user that device 200 is not properly positioned and as such that a fluid-tight seal is not present between the device 200 and the user's tissue. Simultaneous with, before or after activation of such first feedback indicator, processor 3224 activates pump 1010 to commence evacuation of the interior cavity of suction chamber 220, as indicated in a step 3609.

A second feedback indicator can be activated during the evacuation period, as indicated in a step 3611. The second feedback indicator can be of any suitable type, for example any of first feedback indicators set forth above. In one embodiment, the second indicator includes a second visual feedback indicator such as a second activation sequence of one or all of first indicators or LEDs 283 that is different than the first visual feedback indicator. One such second activation sequence is a continuous illumination or repeated pulsing illumination of at least one of LEDs 283, for example a continuous purple illumination or repeated pulsing purple illumination of one or more LEDs 283. In one embodiment, the second feedback indicator includes a second audible feedback indicator such as an audible signal or noise generated by the device, which can be heard by the user and is different than the first audio feedback indicator. In one embodiment, the second feedback indicator includes a second tactile feedback indicator such as a vibration or other sensation generated by the sexual arousal device or device of the invention, such as for example a second pulsing sequence of vibratory motors 280 that can be felt by the user, which is different than the first tactile feedback indicator. One such second pulsing sequence is a repeated pulsing of at least one of vibratory motors 280. In one embodiment, the continuous illumination repeated pulsing illumination of at least one of the LEDs 283 and pulsing of at least one of vibratory motors 280 occurs simultaneously. Second feedback indicators can serve to alert the user that the evacuation sequence of the sexual arousal device is proceeding properly and that no adjustment of the device with respect to the tissue of the user is necessary at this time. In this regard, for example, the second feedback indicator can be activated throughout the operation of the pump so as to advise the user of the continued evacuation of the suction chamber 220.

During the evacuation sequence a current pressure value can be sensed or measured on a periodic basis in the pump, as indicated in a step 3613. Such sensed pressure is compared by processor 3224 to one or more other pressure values sensed in the pump, for example one or more earlier sensed pressure values, as indicated in a step 3615. In a step 3621, it is determined by the processor 3224 by such comparison of step 3615 whether the pump 1010 is progressing in a suitable manner towards achieving the target negative pressure in suction chamber 220. A determination that the pump is not proceeding in a suitable manner towards achieving the target negative pressure can be made in one or more ways. For example, such a determination may be made when a comparison of one or more sequential pressure measurements shows a continued or sudden increase in pressure, indicating for example that a leak or breach has occurred between the suction flange 225 and the user's tissue. Such breach of seal or leak could occur, for example, because of movement of the user, movement of the device or movement of both. Such a determination may be made when a comparison of one or more sequential pressure measurements shows no increase in negative pressure in chamber 220 despite continued pumping. Such a determination may be made when a comparison of one or more sequential pressure measurements shows that the negative pressure in chamber 220 has dropped below a threshold pressure. Such threshold pressure can be atmospheric pressure or a pressure below atmospheric pressure. It is appreciated that a variety of other pressure measurement comparisons can be provided and utilized to determine that the pump is not progressing in a suitable manner towards the target negative pressure. Such pressure threshold value or other determination characteristics or algorithms can be stored in controller block 215, for example in a lookup table or otherwise in storage 3228. If it is determined that the pump is progressing in a suitable or desired manner towards achieving the target negative pressure in suction chamber 220, in step 3621, the process returns to step 3613 to receive a pressure value for the next pump cycle. If in contrast it is determined that the pump is not suitably progressing towards reaching the target negative pressure in suction chamber 220, processor 3224 turns off the pump, as indicated in a step 3623.

Steps 3613 through 3621 can be performed during all or any portion of the evacuation cycle. In one embodiment, steps 3613 through 3621 are performed until a certain negative pressure is achieved in suction chamber 220. In one embodiment, such certain negative pressure is when suction flange has sealed to the user's tissue. The certain negative pressure can be predetermined, precalculated, calculated during operation of the sexual arousal device of the invention or any combination of the foregoing.

A third feedback indicator can be activated after the pump 1010 is turned off in step 3623 during evacuation, as indicated in a step 3625. The third feedback indicator can be of any suitable type, for example any of first or second feedback indicators set forth above. In one embodiment, the third indicator includes a third visual feedback indicator such as a third activation sequence of one or all of first indicators or LEDs 283, or a cessation thereof, which is different than both the first and second visual feedback indicators. One such third activation sequence is a cessation of the continuous illumination or repeated pulsing illumination of at least one of LEDs 283. In one embodiment, the third feedback indicator includes a third audible feedback indicator such as an audible signal or noise generated by the device, or a cessation thereof, which can be heard by the user and is different than both the first audio feedback indicator and the second audio feedback indicator. In one embodiment, the third feedback indicator includes a third tactile feedback indicator such as a vibration or other sensation generated by the sexual arousal device, or a cessation thereof, which is different than both the first tactile feedback indicator and the second tactile feedback indicator. One such third tactile feedback indicator is a cessation of the repeated pulsing of at least one of vibratory motors 280. Third feedback indicators can serve to alert the user that the seal between the sexual arousal device of the invention, for example device 200, and the user's tissue has been breached, that the evacuation of the suction chamber 220 has ceased, that the device 200 is overheating or in risk of overheating and must be deactivated for a while, that the device 200 is not achieving a seal with the user's tissue, that the suction chamber 220 needs to be repositioned or any combination of the foregoing. In one use of process 3600, the user commences repositioning the device and the process returns to step 3601.

The feedback indicators of the invention are not limited to indicators generated by device 200, but can include indicators generated by other devices that are remote to device 200 and wired or wirelessly connected to the device 200. Such remote devices can include smart phones or any other mobile or handheld device.

Process 3600 advantageously minimizes the usage of pump 1010 during evacuation of suction chamber 220. As a result, excess heating or overheating of device 200 can be minimized. In addition, the battery life of the device, for example the life of battery 212, can be conserved.

Upon achieving the target negative pressure, pump 1010 is operated as necessary to maintain the desired negative pressure or vacuum or range thereof in chamber 220. Such negative pressure or vacuum range can be referred to as the operational negative pressure or vacuum range. In one embodiment, the operational vacuum range is sufficient to retain the active simulators 280 in engagement with the clitoris of the user during operation of stimulators 280. In one embodiment, where the active stimulators are vibratory motors 280, the operational vacuum range is sufficient to retain the active simulators 280 in engagement with the clitoris of the user during operation of stimulators 280. In one embodiment, the operational vacuum range of the sexual arousal device of the invention is between approximately negative 2.5 and approximately negative 8.0 inches of mercury. In one embodiment, the operational vacuum range is between approximately negative 4.75 and approximately negative 6.5 inches of mercury. In one embodiment, the operation vacuum range of the sexual arousal device is between about negative 3.0 to about negative 5.0 inches of mercury. In one embodiment, the operational vacuum range of the sexual arousal device is between about negative 3.9 to about negative 5.0 inches of mercury.

The sexual arousal device of the invention, including the controller thereof, for example controller block 215, processor 3224 or both, can be configured to maintain the vacuum pressure in chamber 220 in a desired operational range after the target negative pressure has been achieved and pump 1010 turned off. An exemplary sequence of steps of one embodiment of a process 3700 performed by a control system to maintain the pressure in suction chamber 220 within such an operational vacuum range is illustrated in FIG. 23F. Periodic pressure loss in chamber 220 can occur from small leaks between sealing flange 225 and the user's tissue, from movement of the user, from movement of the device 220 or any combination of the foregoing or other circumstances. Process 3700 can be used separately or in combination with any of the other processes herein or otherwise. For example, some or all of process 3700 can be used in combination with process 3300, process 3500, process 3600 or any combination of the foregoing. In this regard, the process may be utilized with a manual operating mode or an auto-attach mode.

In a step 3701, such controller or processor 3224 receives a current measured pressure value, for example from pressure sensor 1080 in the pump, during a session of the sexual arousal device. In a step 3703, processor 3224 determines whether such measured pressure is within the operational vacuum range of the device. If yes, the process is directed back to step 3701. If no, pump 1010 is activated, as indicated in a step 3705, to further reduce pressure in chamber 220, for example to achieve again the targeted negative pressure. During the operation of pump 1010, the pressure in suction chamber is measured again in a step 3711. In one embodiment, the pressure in suction chamber 220 is measured multiple times in step 3711 in any suitable time sequence over any suitable duration. In a step 3713, the processor 3224 compares at least one of the measured pressures from step 3711 to the target negative pressure. If the pump 1010 has successfully increased the negative pressure in chamber 220 to the target negative pressure, the pump is turned off, in a step 3715. Thereafter, the process returns to step 3701 to begin process 3700 again.

If the chamber vacuum pressure remains below the operational vacuum range, as determined in step 3713, the pump remains on. In a step 3721, the processor compares the one or more pressures measured in step 3711 to each other, to the pressure measured in step 3701 or any combination of the foregoing. In a step 3723, the processor utilizes the pressure comparisons of step 3721 to determine whether the pump 1010 is progressing towards returning the pressure in suction chamber 220 to the target negative pressure. Any suitable algorithm can be utilized by the processor 3224 in step 3723. A determination that the pump is not progressing towards the target negative pressure may be made when a comparison of one or more sequential pressure measurements shows a continue or sudden increase in pressure, indicating for example that a leak or breach has occurred between the suction flange 225 and the user's tissue, for example for any of the reasons discussed above. Such a determination may be made when a comparison of one or more sequential pressure measurements shows no increase in negative pressure in chamber 220 despite continued pumping. Such a determination may be made when a comparison of one or more sequential pressure measurements shows that the negative pressure in chamber 220 has dropped below a threshold pressure. Such threshold pressure can be atmospheric pressure or a pressure below atmospheric pressure. In one embodiment, such threshold pressure is a predetermined or precalculated pressure at which the suction flange 225 is deemed unsealed from the tissue of the user. It is appreciated that a variety of other pressure measurement comparisons can be provided and utilized in step 3723 to determine that the pump is not progressing in a suitable manner towards the target negative pressure. Such pressure threshold value or other determination characteristics or algorithms can be stored in controller block 215, for example in a lookup table or otherwise in storage 3228. If it is determined that the pump is not progressing in a suitable or desired manner towards achieving the target negative pressure in suction chamber 220, in step 3723, processor 3224 turns off the pump, as indicated in a step 3725. In one option, the user can then attempt to reattach the sexual arousal device to tissue surrounding the clitoris, in which case process 3600 is commenced again by the device. If processor 3224 determines that the pump 1010 is progressing in a suitable manner towards achieving the target negative pressure in suction chamber 220, in step 3723, the process returns to step 3711 to measure again the pressure in suction chamber 220 and proceed again to determination step 3713.

Upon achieving the target negative pressure in suction chamber 220, the active stimulators 280 in chamber 220 and disposed about the clitoris are activated by processor 3224 to commence a session of clitoris stimulation. Whether activated in a manual attachment or auto-attach mode, the plurality of active stimulator 280, which in one embodiment are vibratory motors 280, can be operated in any suitable manner and order. For example, vibratory motors can be activated sequentially, that is one after other, in a circumferential order with respect to the clitoris. Alternatively, the vibratory motors 280 can be activated in any other alternating sequence, such as in a V pattern, or all activated simultaneously. Power to the vibratory motors 280 can be adjusted in any suitable manner so as to adjust the level of vibration of the motors. The activation and level of vibration of each of the vibratory motors 280 can be independently controlled, for example by processor 3224 through programming or user input.

In one embodiment, the flexible suspension of each of the vibratory motors 280 within the suction chamber enhances the stimulation of the clitoris as the clitoris and surrounding tissue becomes engorged. Prior to such tissues becoming engorged, the negative pressure or suction within suction chamber 220 pulls motor membrane 5190 and the vibratory motors 280 disposed in the membrane 51990 into contact with the clitoris and surrounding tissue. As such tissues become engorged, the motor membrane 5190 and vibratory motors 280 are pushed back by the engorged tissue, but stay in contact with such tissues. In this manner, the flexible suspension of the vibratory motors can provide for a more consistent stimulation by the vibratory motors 280 and reduce discomfort to the user.

The sexual arousal device of the invention can be provided with a fourth feedback indicator that can be activated after the target negative pressure has been achieved. The fourth feedback indicator can be of any suitable type, for example any of first or second feedback indicators set forth above. In one embodiment, the fourth indicator includes a fourth visual feedback indicator such as a fourth activation sequence of one or all of first indicators or LEDs 283, or a cessation thereof, which is different than both the first, second and third visual feedback indicators. One such fourth activation sequence is a continuous illumination of at least one of LEDs 283. In one embodiment, the fourth visual feedback indicator is a single multicolor LED continuously illuminating in a single color, for example the color purple. In one embodiment, the fourth feedback indicator includes a fourth audible feedback indicator such as an audible signal or noise generated by the device, or a cessation thereof, which can be heard by the user and is different than any of the first audio feedback indicator, the second audio feedback indicator and the third audio feedback indicator. In one embodiment, the fourth feedback indicator includes a fourth tactile feedback indicator such as a vibration or other sensation generated by the sexual arousal device, or a cessation thereof, which is different than any of the first tactile feedback indicator, the second tactile feedback indicator and the third tactile feedback indicator. One such fourth tactile feedback indicator is a commencement of a commencement of a session of clitoris stimulation by vibratory motors 280, for example in any of the vibratory motor 280 activation sequences described above. Fourth feedback indicators can serve to alert the user that the target negative pressure has been achieved in suction chamber 220 and the sexual arousal device has commenced a tissue stimulation session.

In one method of operating the sexual arousal device of the invention, activation of the one or more active stimulators or vibratory motors in any of the foregoing operation configurations causes power to be provided to the activated stimulators at a relatively low level so that each of the activated motors provides only a relatively modest amount of vibration. In one embodiment, the level of power provided to each of the vibratory motors can be adjusted by the user, for example increased from the initial low level to a medium level and to a high level so that the amount of vibration produced by the motor respectively increases to a medium level and to a high level. Other power and operation levels for vibratory motors 280 can optionally be provided. In one embodiment, the level of warmth generated by each of the operating vibratory motors 280 increases with the power supplied to the motors and the resulting vibration of the motors. A certain level of warmth generated by the vibratory motor can be beneficial to achieving sexual arousal, and thus beneficial to the stimulation session of the sexual arousal device.

In one embodiment of the sexual arousal device of the invention, such as device 200, the temperature of the vibratory motors 280 can be monitored, for example to guard against damage to the user's tissue adjacent to the vibratory motors 280. In this regard, one or more suitable temperature sensors, such as temperature sensors 5242, can be provided in suction chamber 220 or on each vibratory motor. In one embodiment, a temperature sensor 5242 is provided adjacent the chamber 220 on each of the vibratory motors 280 in the vicinity of the tissue of the user, for example where the vibratory motor 280 stimulates the user's clitoris. In one embodiment, a feedback and control mechanism or system can be included in device 200 for adjusting the power supplied to each of the operating vibratory motors 280 in response to the respective measured temperature of the vibratory motor in a vicinity of the tissue of the user being stimulated by the vibratory motor. In one embodiment, the temperature of each motor in the vicinity of the user's tissue is monitored by the controller of device 200, for example control block 215 or processor 3224, and such controller reduces the power to or turns off a vibratory motor 280 when such temperature exceeds a predetermined maximum temperature. In one embodiment, the controller turns off all of the vibratory motors when any of such measured temperatures exceeds the predetermined maximum temperature. In one embodiment, the predetermined maximum temperature is a temperature above human body temperature before which the user's tissue suffers heat damage, for example from the heat generated by a vibratory motor 280. In one embodiment, the predetermined maximum temperature is approximately 43° C.

In one embodiment, for example where all of the vibratory motors 280 are being operated at a same high power level, the controller of the sexual arousal device of the invention, for example processor 3224 thereof, is configured to limit the amount of power supplied to each of the motors to a maximum power level that can likely be maintained continuously throughout a stimulation session of the device without causing any of the measured temperatures at the vibratory motors to exceed the predetermined maximum temperature during the session. The maximum power level can be predetermined or precalculated, and can be dynamically adjusted during the session as a function of the measured temperatures by the temperature sensors 5242 in the vicinity of the user's tissue being stimulated by the vibratory motor. Throughout the session, the temperature at each sensor 5242 is above ambient temperature and above the body temperature of the user, but below the predetermined maximum temperature. In one example of operation of the sexual arousal device of the invention, controller block 215 is configured upon a user's command to operate all of the vibratory motors 280 at a predetermined high level, for example at a high percentage of the individual maximum power level of the each vibratory motor 280. Under typical operational conditions, such predetermined high level of operation of the vibratory motors would not cause the temperature of the user's tissue being stimulated by the motors to exceed the predetermined maximum temperature. However, if ambient conditions around the sexual arousal device result in the temperature of stimulated tissue, as for example measured by temperature sensor 5242, to approach the predetermined maximum temperature as a result of the respective motor overheating or becoming too hot, the controller block 215 is configured to lower the power level of such vibratory motor to a lower operational level that will permit the vibratory motor to continue operating and not cause the temperature adjacent the stimulated tissue to exceed the predetermined maximum temperature. In one embodiment, the controller block 215 reduces the power to all of the vibratory motors to such lower operational level if the measured temperature for any one of the vibratory motors approaches the predetermined maximum temperature. Continuous operation of the device during a stimulation session, for example without the need of deactivating any or all of the vibratory motors so as to avoid tissue damage to the user, can enhance the enjoyment of session.

In one embodiment, additional temperature inputs can be provided, for example by temperatures sensors on the sexual arousal device or elsewhere, for measuring the ambient temperature in the vicinity of the device during the session. In one embodiment, ambient temperature can be periodically or continuously monitored by temperature sensor 5241. Such additional temperature inputs can be utilized by the controller of the sexual arousal device for predetermining or precalculating the maximum power level, either before the session or dynamically during the session, at which all of the vibratory motors 280 can be continuously operated.

As indicated above, the pump of the sexual arousal device of the invention, for example device 200, can be activated and deactivated repeatedly during a procedure utilizing the device, both for example during the evacuation of suction chamber 220 and while maintaining a vacuum in the suction chamber during a session utilizing the device 200. One suitable pump for use in the device is a miniature pump, such as for example a miniature diaphragm pump having a voice coil actuator. Examples of such a miniature pump include pumps 10 and 1010 described above. As illustrated in FIGS. 13A and 13B with respect to pump 10, a voice coil actuator 15 can be included in the pump and include a voice coil magnet 7 and an electromagnetic coil or actuator coil 3 moveable relative to magnet 7 when energy is supplied to the coil 3. A support member or actuator membrane is coupled to the coil 3 and a diaphragm 55 and permanent magnet 57 are coupled to the support member 5 and moveable with the coil 3 and support member 5 between a first position, for example as illustrated in FIG. 13B, and a second position, for example as illustrated in FIG. 13A. The actuator membrane, coil 3, diaphragm 55 and permanent magnet move against a changing negative pressure in the suction chamber 220 in a first or evacuation stroke from the first position to the second position, and move in a second stroke from the second position back to the first position. The pump can include a permanent magnet, such as permanent magnet 57, to improve the efficiency of the pump, particularly when the pump may face a large negative pressure from the suction chamber 220 such as when the pressure in the suction chamber approaches the target negative pressure. The pump encounters the pressure of the suction chamber throughout its evacuation stroke. The energy needed to move diaphragm 55 during the evacuation stroke increases with the increase in negative pressure in the suction chamber 220. The permanent magnet 57 serves to urge the diaphragm 55 towards the voice coil magnet 7 during the evacuation stroke of the pump. In this regard, the attraction of the permanent magnet to the voice coil magnet contributes to the movement of the diaphragm 55 and its associated components from the first position to the second position during such evacuation stroke and can thus reduce the power necessary to drive the pump during its evacuation stroke. The controller of device 200 is electrically coupled to the pump 10, including coil 3 thereof, for supplying electrical energy to the pump when needed for regulating the pressure in suction chamber 220.

In one method of operating the miniature pump 10 or 1010 of the sexual arousal device of the invention, a suitable waveform is periodically supplied to the actuator coil 3 of the pump by the controller of the device. The energy waveform supplied to the actuator coil 3 can be of any suitable type, such as a sinusoidal waveform, a square waveform or any similar waveform centered by a first amplitude on an offset energy level, which for example is greater than zero. One suitable energy waveform is illustrated in FIG. 24. In one embodiment, the first amplitude can range from about zero to 150. In one embodiment, the offset can range from about zero to 200, with 100 being neutral. In one embodiment, the controller of the sexual arousal device of the invention is configured upon activation of the pump to provide initial energy to the coil 3 at a second amplitude greater than the first amplitude. Such an initial high energy or energy boost to the pump can be useful for initiating movement of the permanent magnet 57 away from the voice coil magnet 7, towards which the permanent magnet 57 can reside when no energy is being supplied to the voice coil 3, and commence oscillation of the diaphragm 55. In some instances, the permanent magnet 57 can cause the support member to contact and sit on the voice coil magnet 7 when the pump is not being powered. The initial energy boost to voice coil actuator 15 can counteract the strong attraction of the permanent magnet 57 to the voice coil magnet 7 and the relatively large initial force required to separate the permanent magnet from the voice coil magnet.

In one embodiment, the controller of the sexual arousal device of the invention is configured to upon deactivation of the pump to gradually reduce energy to the coil at a negative slope from the offset energy level to zero so as to gently return the support member to the rest position. Such gradual return of the permanent magnet 57 to its rest position can counteract the strong attraction forces drawing the permanent magnet 57 towards the voice coil magnet 7 and provide a soft landing for the permanent magnet and thus provide a quieter pump on deactivation.

During the operation of the pump of the sexual arousal device, the pump typically faces a changing pressure in the suction chamber 220. During evacuation for example, the negative pressure in the chamber 220 gradually increases towards the target negative pressure. As the pressure faced by the pump in its first or evacuation stroke increases, in one embodiment the controller of the sexual arousal device is configured to increase the energy being supplied to the pump. In one embodiment, the controller is configured to adjust the amplitude, the offset energy level or both in the energy waveform controlling the pump as a function of the changing negative pressure faced by the pump.

In one embodiment of the operation of pump, the controller of the sexual arousal device of the invention is configured increase the amplitude of the energy waveform being supplied to the pump as the pressure in suction chamber 220, and thus the pressure being faced by the pump in its evacuation stroke, approaches the target negative pressure. In one embodiment, the controller increases the amplitude of the input energy waveform when the negative pressure in the suction chamber reaches a predetermined or precalculated negative pressure, for example negative five inches of mercury. Such increase in the amplitude can be in addition to any change of the amplitude, offset energy level or both of the input waveform as a function of the changing negative pressure faced by the pump, as discussed above.

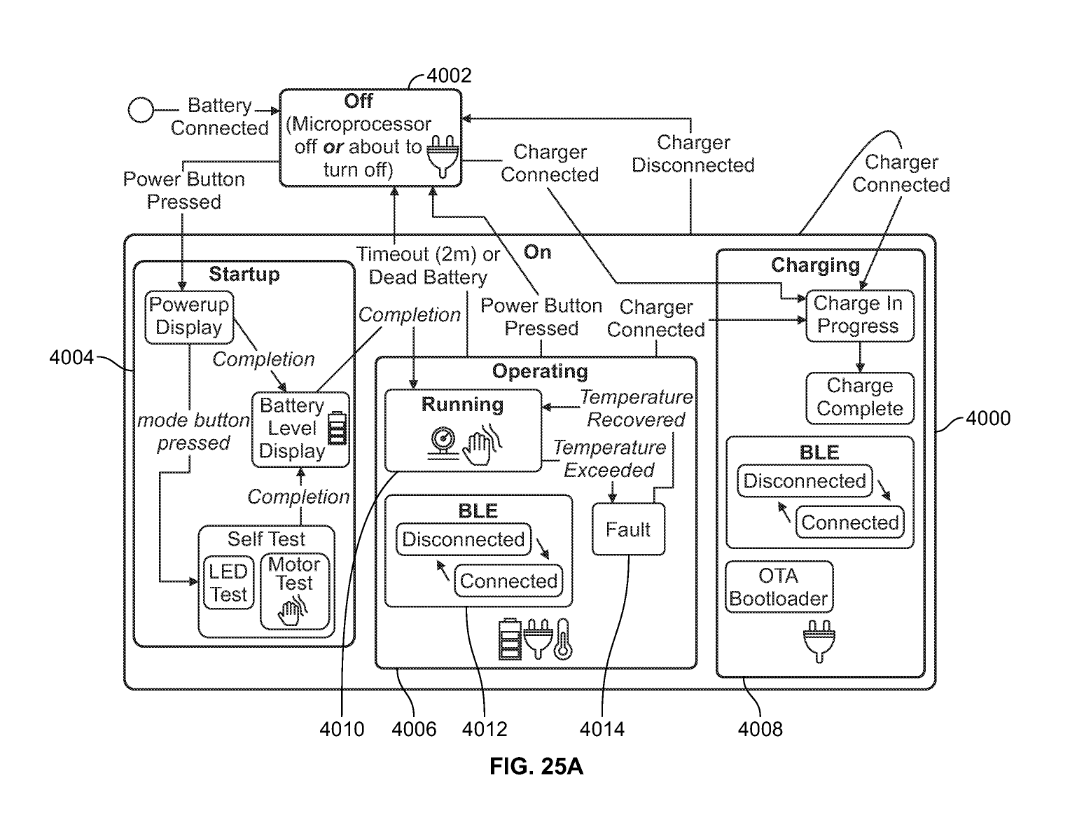

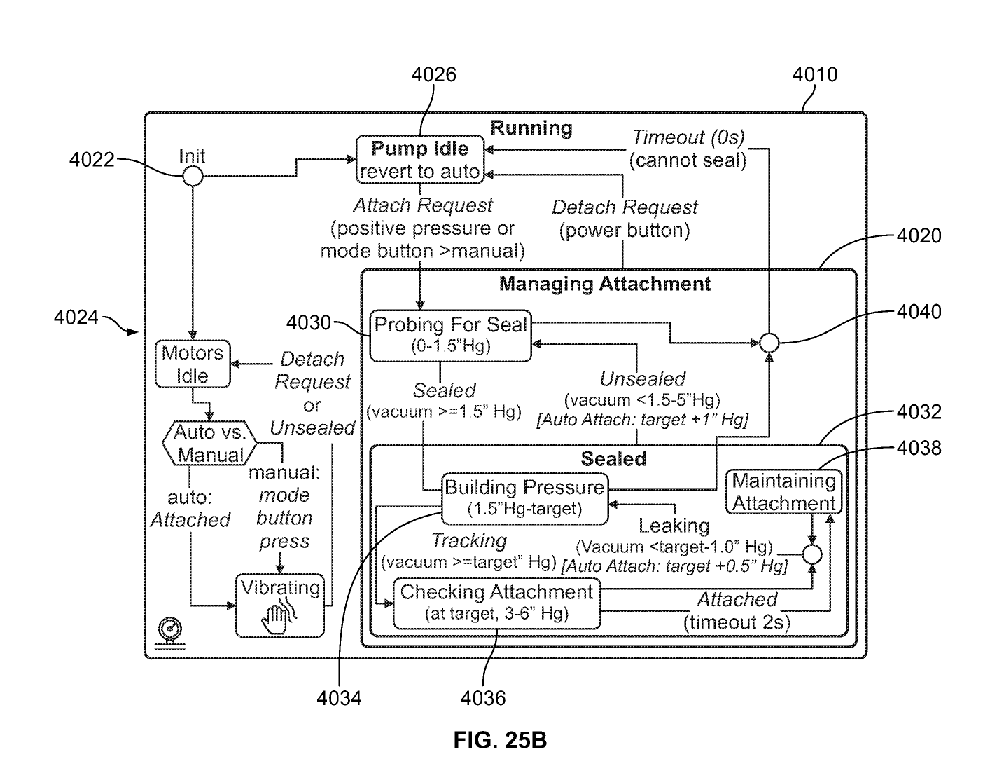

FIGS. 25A and 25B show exemplary state diagrams illustrating the operation of a finite state machine (FSM) implemented using processor 3224 according to some embodiments of the present invention. FIG. 25A shows a system-level diagram illustrating a number of startup, operating and charging states and associated state transitions, while FIG. 25B illustrates a number of operating state substrates used to manage an attachment of the device, including an auto-attachment process according to some embodiments of the present invention. The diagrams of FIGS. 25A and 25B include multiple hierarchical state levels, and the system may be in more than one of the illustrated states at the same time. Entry and exit to/from each described state comprises execution of entry and exit code associated with the given state and/or state transition. The exemplary pressure values illustrated in FIG. 25B are absolute values, which may correspond to negative pressure values.

As shown in FIG. 25A, processor 3224 may be in an on-state 4000 or an off-state 4002. On-state 4000 includes a startup sub-state 4004, an operating sub-state 4006, and a charging sub-state 4008. The system transitions from off state 4002 to startup state 4004 upon detection of a power button user input. Start-up state 4004 includes a powerup display state, a battery level display state, and a self-test state. The self-test state includes LED test and motor test states, in which self-tests of systems LEDs and motors are performed, respectively. The system transitions from the powerup display state to the self-test state upon detection of a mode button user input. Upon completion of powerup display and battery level display sequences, and optionally a self-test sequence, the system transitions to a running state 4010 of operating state 4006.

Running state 4010 embodies a number of operations described in detail above, and in particular a number of attachment management steps and states described below with reference to FIG. 25B. As shown in FIG. 25A, operating state 4006 further includes a remote control communication (Bluetooth) management state 4012 which manages a remote control connection, and a temperature fault management state 4014 activated in response to detection of an excessing temperature by a temperature sensor.

The system may enter charging state 4008 from off state 4002 or from on-state 4000. Charging state 4008 includes charge-in-progress, charge complete, remote control (Bluetooth) management, and over-the-air (OTA) boot loader (initialization) states.

As shown in FIG. 25B, running state 4010 includes an attachment management state 4020 used to manage an attachment of the suction chamber to user tissue through operation of the on-board suction pump. The system may enter attachment management state 4020 from an initial state 4022 through a pump idle state 4026. The system may also transition from initial state 4022 to a set of device motor management states 4024, whose operation is described above. In some embodiments, the system may operate in attachment management state 4020 and device motor management states 4024 substantially concurrently, and operations embodied by attachment management state 4020 and device motor management states 4024 may be performed substantially concurrently.

A transition from pump idle state 4026 to attachment management state 4020 occurs in response to detection of a manual or automatic attachment request/command, and triggers a start of the on-board suction pump. In manual mode, a manual attachment request comprises a user's express action to start the device pump. In auto-attach mode, an automatic attachment request is triggered by detection of a positive pressure value (relative to atmospheric/ambient pressure), which indicates that air has been trapped and compressed in the suction chamber by a user's sealing the suction chamber against user tissue.

An exit from attachment management state 4020 back to pump idle state 4026 occurs upon a timeout of a predetermined duration indicating a failure to establish a seal, as illustrated at 4040 in FIG. 25B. In some embodiments the predetermined duration may have a value between 3 and 30 seconds, more particularly between 5 and 15 seconds, and in an exemplary embodiment about 10 seconds (e.g. 9-11 seconds). A short duration may lead to unnecessary demands on the user's attention, while a long duration may lead to undesirable effects on device operation and durability, for example due to battery discharge and unnecessary heating. As described below, the sufficiency of a seal may depend on the physical seal established along flange 225 (see FIGS. 1A-1D) and the ability of the suction pump to overcome any leaks over a time interval before an exit to the pump idle state is triggered. In some embodiments, the sufficiency of a seal may be evaluated according to different measured parameters or a different analysis, for example by explicitly evaluating the time-dependence (e.g. derivative) of measured pressure, and/or explicitly tracking a seal-quality function dependent on pressure and time.

As shown in FIG. 25B, the system enters a probing-for-seal state 4030 in response to receiving an attachment request. An exit from the state occurs to a sealed state 4032 if a seal has been detected, or through timeout to pump idle state 4026 if a seal has not been detected, as illustrated at 4040. In some embodiments, a sufficient seal for entry into sealed state 4032 is represented by detection before timeout of a vacuum, or negative pressure with respect to atmospheric/ambient pressure, having a predetermined absolute value. In some embodiments the predetermined value may be between −0.5″ Hg and −3″ Hg, for example between about −1 and −2″ Hg, more particularly between about −1.25″ and −1.75″, for example about −1.5″ Hg. A measured negative pressure value of −1.5″ Hg was chosen in some embodiments to be −0.5″ Hg below a baseline value of about −1″ Hg, below which pressure measurements may not yield useful or reliable information. Such a non-zero baseline value may be due at least in part to backpressure or fluid impedance in the pressure measurement path caused by filters or other physical obstructions which may lead measured pressure values to differ from actual pressure values, and particularly to difficulty in measuring negative pressures above −1″ Hg due to impedance in the flow path. For systems with a lower baseline pressure measurement values, a lower seal-detection threshold for the measured pressure (e.g. −0.5″ Hg) may be used.

Detection of a seal leads to a building-pressure state 4034. Exit from building-pressure state 4034 can occur through timeout, illustrated at 4040, or by achieving a predetermined negative target pressure. In some embodiments, the target pressure has a settable value within an allowed range. In some embodiments, the allowed range may be between about −1″ Hg and about −8″ Hg, for example between about −3″ Hg and about −6″ Hg. The lower bound of the range may be set to exclude target pressure values that are considered too low to provide desired user sensations and/or ensure attachment, while the higher bound of the range may be set to a value beyond which device use may be uncomfortable to users. Such an upper bound may depend on device materials and geometry (e.g. suction cavity depth). In manual mode, the target pressure may be changed manually by a user in predetermined increments (e.g. 1″ Hg or 0.5″ Hg) using plus and minus pressure controls. In autoattach mode the target pressure may be adjusted automatically to maintain attachment as described below. In addition, in an alternating suction mode, the target pressure may be adjusted automatically between user-selected or pre-programmed lower and upper pressure levels.

If the target pressure has been attained before expiration of the timeout interval, the system enters an attachment-confirmation (checking attachment) state 4036. Exit from checking-attachment state 4036 can occur to an attached (maintaining attachment) state 4038 if attachment (pressure at target or within 1″ Hg) is confirmed for a predetermined interval (e.g. 1-5 seconds, for example about 2 seconds), or back to building-pressure state 4034 if a leak is detected before expiration of the attachment confirmation time interval. The presence of a leak may be represented by the detection of a negative pressure lower (in absolute value) than the target pressure by a predetermined value (e.g. 1″ Hg, larger than an exemplary pump dynamic hysteretic band of 0.5″ Hg described below), indicating that the pump suction cannot keep pace with the volume of air leakage. Upon exit back to building-pressure state 4034, in the autoattach mode the target pressure is automatically decremented by a predetermined interval, e.g. about −0.5″ Hg or −1″ Hg, which represents an increase in the absolute value of the target pressure. Decrementing the target pressure facilitates maintaining attachment under the current, dynamically variable conditions which may depend on the anatomy of the particular user and the way the device is being currently used (e.g. position relative to the user's anatomy, the user's position and range and type of motion, etc.).

In attached (maintaining attachment) state 4038, the pump may be turned on periodically to maintain the measured pressure within a predetermined interval of the target pressure (e.g. ±0.5″ Hg), which defines a dynamic hysteretic band of the pump. The pump is turned off otherwise to conserve battery, prevent overheating and maintain user comfort.

An exit to building-pressure state 4034 represents a slow leak. A leak has been detected, but is not necessarily so fast so as to lead to a loss of attachment. Consequently, a decrease in the negative target pressure by a relatively small increment (e.g. −0.5″ Hg), representing an increase in the absolute value of the target pressure, may lead to a restoration of attachment in the current dynamic conditions.

An exit from sealed state 4032 to probing-for-seal state 4030 represents a fast leak, one that had led to a measured pressure below −1.5″ Hg. In some embodiments, the target pressure is decremented by a larger increment (e.g. about −1″ Hg) when such a transition occurs in autoattach mode, to facilitate attachment in more challenging conditions (e.g. the user is moving around more, or has a distinctive anatomy requiring higher suction to maintain attachment).

The exemplary finite state machine states described above effectively track or represent a quality of the seal established between the suction chamber and the user's tissue: different FSM states represent different seal qualities. State transitions triggered by pressure changes while the suction is running effectively track leak events, and are used to automatically increase the target pressure in order to reduce the frequency or probability of device detachment without any immediate user input or interaction. Multiple state transitions, each representing a different leak speed or corresponding seal quality (e.g. corresponding to slow and fast leaks), can be particularly useful because of the inherent time lag between the initiation of pumping and the detection of pressure changes, and because of the transient nature of some leaks. For example, a user may break a seal for just a moment and then readjust position, leading to a transient leak which may be adequately addressed by a small adjustment to the target pressure.

In some embodiments, the target pressure is reset to its default value upon an exit to the pump idle state 4026, or upon detection of any user input (e.g. the press of any button). In some embodiments, an updated default target pressure may be determined and stored in non-volatile memory for future reuse upon determination that a frequency of detachment and/or leak events meets a predetermined condition. For example, if a target pressure of −3″ Hg leads to frequent detachment for a particular use, it may be inferred that a lower default target pressure (e.g. −3.5″ Hg or −4″ Hg, corresponding to a higher absolute value) may be appropriate for that particular user given her anatomy and usage patterns, and that default target pressure is stored in non-volatile memory and reused until a reset event is triggered manually or automatically (e.g. through a long-term timer or determination that detachment events are sufficiently infrequent).

Generally, a lower absolute value of a target pressure needed to maintain an adequate seal is desirable due to patient comfort with lower pressures, and the increased dynamic range available operation in an alternating suction mode. For example, if the target pressure is −3″ Hg and the maximum suction pressure in an alternating suction mode is −8″Hg, a dynamic range of 5″ Hg is available for the alternating suction mode. A lower dynamic range may lead to decreased sensation as the user's mechanoreceptors adjust over time to a given level of suction.

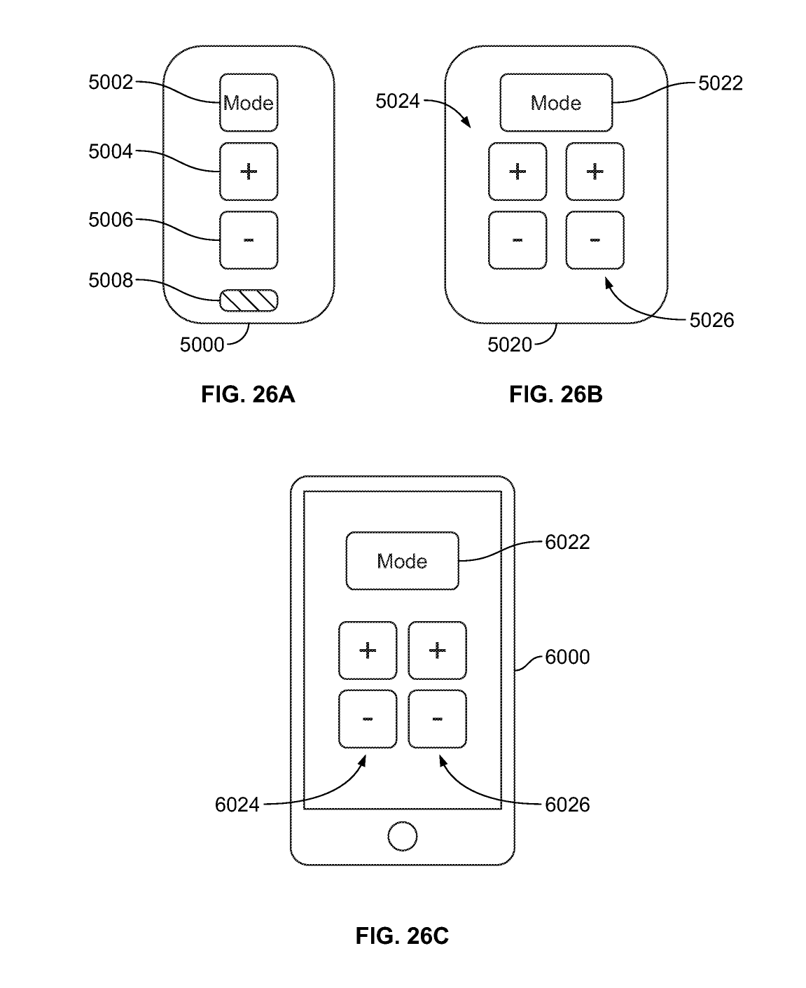

FIGS. 26A-C illustrate exemplary user interfaces suitable for an on-device interface (FIG. 26A), a remote control (FIG. 26B), and a remote control implemented as an application running on a smartphone or other general-purpose mobile device (FIG. 26C), according to some embodiments of the present invention. The exemplary illustrated user interface designs embody a given tradeoff between ease/simplicity of use on the one hand, and customizability of operation on the other.

An on-device user interface 5000 includes a mode button 5002, plus and minus buttons 5004, 5006, and a display LED 5008. The display LED 5008 may be positioned to face downward as the device is used. A user interface 5020 implemented on a remote control may have a larger surface available for controls, and may include a mode button 5022, and two separate plus-minus button pairs 5024, 5026, each controlling a different parameter or device (e.g. suction and stimulators). A similar design may be used in a smartphone user interface 6000, which includes a mode button 6022 and two level-adjustment button pairs 6024, 6026.

In some embodiments, the mode button controls device transitions between manual and automatic (auto-attach) operation modes. In some embodiments, at least some interactions with the mode button (e.g. a short/long press on the on-device mode button) may control transitions between suction/pressure control and stimulator control operation modes for the level adjustment (plus minus) buttons. Exemplary embodiments are described below.

In some embodiments, the on-device user interface level-adjustment buttons 5004, 5006 default to a mechanical stimulator control mode, and the device is by default in an automatic attachment operation mode. A short press on the mode button 5002 changes the response to level-adjustment buttons 5004, 5006 to a suction/pressure control mode for a predetermined time period (e.g. 5 or 10 seconds), after which the system reverts to its default.

In some embodiments, all mechanical stimulators are turned off automatically upon a transition to suction control mode. Turning off the mechanical stimulators signals to the user that the device is now in suction control mode, and allows the user to more finely choose a desired level of suction without sensory (tactile and auditory) interference from the motors.

Once attachment is established, the level control buttons revert to mechanical stimulator control mode and the mechanical stimulators can start (or restart).

In some embodiments, a long press on one of the mode buttons triggers entry into an alternating suction mode. In some embodiments, the default peak suction pressure upon entry into the alternating suction mode is at target, so the user has to press a plus button at least once to initiate alternating suction; subsequent presses of the plus/minus buttons increment/decrement the peak suction level. In some embodiments, the default peak suction pressure can also be set to be at one plus target when the alternating suction mode is started.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A sexual arousal device for use by a female, comprising a suction chamber adapted to engage the female's tissue surrounding her clitoris, the suction chamber being configured to allow the clitoris to expand during use, a pump for evacuating the suction chamber when attaching the suction chamber to the female's tissue, a sensor for measuring pressure, at least one stimulator for stimulating the clitoris in the chamber and a controller electrically coupled to the pump, the controller being configured to self-regulate to turn on and off the pump to maintain a certain level of pressure.

2. The sexual arousal device of claim 1, wherein the feedback indicator is selected from the group consisting of an audible indicator, a visual indicator, a tactile indicator and a combination of the foregoing.

3. The sexual arousal device of claim 1, where the controller is configured to activate a feedback indicator distinct from the pump upon the sensor detecting a pressure value above ambient pressure where the feedback indicator advises the female as to the status of evacuation.

4. (canceled)

5. The sexual arousal device of claim 1, wherein the pressure value is a positive pressure that indicates a seal between the suction chamber and the female's tissue surrounding her clitoris.

6. The sexual arousal device of claim 1, further comprising a housing, the suction chamber, the pump and the sensor being carried by the housing.

7. (canceled)

8. (canceled)

9. The sexual arousal device of claim 1, wherein the at least one stimulator includes at least one vibratory motor.

10. The sexual arousal device of claim 1, wherein the controller is configured after activating the pump to activate a feedback indicator distinct from the pump to advise the female as to the commencement of evacuation.

11. (canceled)

12. The sexual arousal device of claim 1, wherein the controller is configured to activate a feedback indicator upon the cessation of the operation of the pump so as to advise the female that evacuation of the suction chamber has ceased.

13. The sexual arousal device of claim 12, wherein the controller is configured to cease operation of the pump when the pump is not progressing towards a target negative pressure in the suction chamber in accordance with a predetermined algorithm.

14. The sexual arousal device of claim 1, wherein the controller is configured to activate a first feedback indicator throughout the operation of the pump so as to advise the female as to the continued evacuation of the suction chamber and the controller is configured to activate a second feedback indicator upon the cessation of the operation of the pump so as to advise the female that evacuation of the suction chamber has ceased.

15. (canceled)

16. (canceled)

17. (canceled)

18. A sexual arousal device for use by a female, comprising a suction chamber adapted to engage the female's tissue surrounding her clitoris, at least one stimulator for stimulating the clitoris in the chamber, at least one sensor for measuring the temperature of the at least one stimulator in the vicinity of the stimulation and a controller electrically coupled to the at least one stimulator and the at least one sensor for controlling the at least one stimulator during a maximum power session, the controller being configured to reduce the maximum power to the at least one stimulator during the maximum power session upon the at least one sensor detecting a temperature value that approaches a predetermined maximum temperature value so as to maintain continuous operation of the at least one stimulator throughout the maximum power session without causing heat damage to the clitoris.

19. The sexual arousal device of claim 18, wherein the at least one stimulator includes a plurality of stimulators and the at least one sensor includes a sensor for measuring the temperature of each of the plurality of stimulators, and wherein the controller is configured to reduce the maximum power to one of the plurality of stimulators during the maximum power session upon the respective one of the plurality of sensors detecting a temperature value that approaches a predetermined maximum temperature.

20. A miniature pump, comprising a voice coil magnet and an electromagnetic coil moveable relative to the magnet when energy is supplied to the coil, a support member coupled to the coil and a diaphragm and permanent magnet coupled to the support member and moveable with the coil and support member wherein the permanent magnet urges the support member towards the voice coil magnet, a controller electrically coupled to the coil for selectively providing energy to the coil in a waveform centered by a first amplitude on an offset energy level.

21. (canceled)

22. The miniature pump of claim 20, wherein the controller is configured upon deactivation of the pump to gradually reduce energy to the coil at a negative slope from the offset energy level to zero so as to gently return the support member to the rest position.

23. (canceled)

24. The miniature pump of claim 20, wherein the controller is configured to adjust at least of the amplitude and the offset energy level as a function of the changing negative pressure.

25. The miniature pump of claim 20, wherein the controller is configured to increase the amplitude when the changing negative pressure exceeds a predetermined negative pressure.

26. The miniature pump of claim 20, wherein the voice coil includes a mass attached to the membrane driven by an electromagnetic field to achieve high amplitude with low voltage.

27. The miniature pump of claim 20, further comprising an upper spacer and a housing, the upper spacer defining an upper portion of a pumping chamber in which the diaphragm reciprocates.

28. (canceled)

29. The miniature pump of claim 20, further comprising an actuator membrane, the magnet attached to a lower surface of the diaphragm and to an upper surface of the actuator membrane.

30. (canceled)

31. (canceled)

32. (canceled)

33. The miniature pump of claim 20, further comprising a lower pump body, the lower pump body including openings and ports configured to complement valve and diaphragm arrangement and to allow for controlled flow of gas or liquid through the lower pump body.

34. (canceled)

35. The miniature pump of claim 20, wherein the waveform is one or more of a sinusoidal waveform or a square waveform.

36. The miniature pump of claim 20, wherein the first amplitude on the offset energy level is greater than zero.

37. (canceled)

38. The miniature pump of claim 20, wherein the controller is configured upon activation to provide initial energy to the coil at a second amplitude greater than a first amplitude.

39. The miniature pump of claim 20, wherein upon deactivation energy to the coil is gradually reduced at a negative slope from the offset energy level to zero.

40. The miniature pump of claim 20, wherein the controller is configured to increase at least one of amplitude ad energy of the waveform as pressure approaches a target pressure.

41. (canceled)

42. (canceled)

43. The miniature pump of claim 20, wherein the pump provides an alternating suction mode including a default peak suction pressure setting and increment and decrement peak suction levels.

44. (canceled)

45. (canceled)

46. The miniature pump of claim 20, wherein the controller controls suction patterns, pre-loaded suction patterns, user-configurable suctions, vibrational patterns, or a macroscopic motion patterns user design a selected customized combination or combinations thereof.

47. (canceled)
